(19) United States
(12) Patent Application Publication
(10) Pub. No.: US 2018/0217870 A1
(43) Pub. Date: Aug. 2, 2018

(54) System And Method For Multi-Tiered Real Time Processing Using Configurable Platform Instances

(71) Applicant: SOCIETA INNOVATIONS IPCO LIMITED, London (GB)

(72) Inventors: Douglas A. STANDLEY, Boulder, CO (US); Matthew R. DODGE, Dana Point, CA (US); Randall E. BYE, Louisville, CO (US)

(21) Appl. No.: 15/748,091

(22) PCT Filed: Aug. 1, 2016
(86) PCT No.: PCT/IB2016/001184

§ 371 Date: Jan. 26, 2018

Related U.S. Application Data
(60) Provisional application No. 62/199,741, filed on Jul. 31, 2015.

(51) Int. Cl. G06F 9/50; G06F 9/445

(52) U.S. Cl. CPC G06F 9/5066; G06F 9/44505

(57) ABSTRACT

An improved system and method are disclosed that enable task specific functionality, including real time processing, to be distributed across multiple configurable platform instances that can be arranged in a single or multi-tiered manner. In one example, the system includes multiple configurable platforms that are each based on an identical architecture. Each configurable platform has a core that is configurable to run services that provide mini runtime environments for blocks. Each service runs at least one block that provides the service with the task specific processing functionality contained within the block. The blocks can generally be run by any of the services. This enables a highly flexible system where the task specific functionally can be shifted around the system as desired by moving the blocks containing the task specific functionality to other services on the same configurable platform instance or on other configurable platform instances.

### CROSS-REFERENCE TO RELATED APPLICATIONS

This application is a Patent Cooperation Treaty Application of U.S. Provisional Application No. 62/199,741, filed Jul. 31, 2015, and entitled SYSTEM AND METHOD FOR MULTI-TIERED REAL TIME PROCESSING USING CONFIGURABLE PLATFORM INSTANCES (Atty. Dkt. No. SNVS-32342), which is incorporated by reference herein in its entirety.

### BACKGROUND

The proliferation of devices has resulted in the production of a tremendous amount of data that is continuously increasing. Current processing methods are unsuitable for processing this data. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a neutral input/output (NIO) platform with customizable and configurable processing functionality and configurable support functionality;

FIG. 1B illustrates one embodiment of a data path that may exist within a NIO platform instance based on the NIO platform of FIG. 1A;

FIGS. 1C and 1D illustrate embodiments of the NIO platform of FIG. 1A as part of a stack;

FIG. 1E illustrates one embodiment of a system on which the NIO platform of FIG. 1A may be run;

FIG. 2 illustrates a more detailed embodiment of the NIO platform of FIG. 1A;

FIG. 3A illustrates another embodiment of the NIO platform of FIG. 2;

FIG. 3B illustrates one embodiment of a NIO platform instance based on the NIO platform of FIG. 3A;

FIG. 4A illustrates one embodiment of a workflow that may be used to create and configure a NIO platform;

FIG. 4B illustrates one embodiment of a user's perspective of a NIO platform;

FIG. 5A illustrates one embodiment of a service configuration environment within which a service is configured at runtime;

FIG. 5B illustrates one embodiment of a block configuration environment within which a block is configured at runtime;

FIGS. 6A and 6B illustrate embodiments of block classes that may be used within the block configuration environment of FIG. 5B;

FIG. 7 illustrates one embodiment of an environment within which configuration information is used to configure two blocks based on the same block class in different ways;

FIG. 8 illustrates one embodiment of an environment within which configuration information is used to configure two services based on the same service class in different ways;

FIG. 9 illustrates one embodiment of an environment with a base block class and multiple blocks based on the base block class;

FIG. 10 illustrates one embodiment of a service built using blocks from the environment of FIG. 9;

FIG. 11 illustrates another embodiment of a service built using blocks from the environment of FIG. 9;

FIG. 12 illustrates an embodiment of an environment in which a NIO platform running the services of FIGS. 10 and 11 is coupled to external sources and/or destinations;

FIG. 13 illustrates one embodiment of a method that may be executed by the NIO platform of FIG. 12 to create and configure a block;

FIG. 14 illustrates one embodiment of a method that may be executed by the NIO platform of FIG. 12 to create and configure a service;

FIGS. 15-17 illustrate embodiments of systems formed by interconnected NIO platforms;

FIGS. 18A-18C illustrate embodiments of how a service or set of services may be distributed across multiple NIO platforms;

FIG. 19 illustrates one embodiment of NIO platforms from the system of FIG. 17 arranged in a hierarchy of a mother node, a supervisor node, and an edge node;

FIG. 20 illustrates one embodiment of a method that may be used to define and create a system of NIO platforms;

FIG. 21 illustrates another embodiment of a system formed by interconnected NIO platforms;

FIG. 22 illustrates one embodiment of a different perspective of the NIO platform instance of FIG. 3B;

FIG. 23 illustrates one embodiment of a hierarchical flow that begins with task specific functionality and ends with NIO platform instances; and

FIG. 24 illustrates another embodiment of a system formed by interconnected NIO platforms.

### DETAILED DESCRIPTION

The present disclosure is directed to a system and method for multi-tiered real time processing using configurable platform instances. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This application refers to U.S. patent application Ser. No. 14/885,629, filed on Oct. 16, 2015, and entitled SYSTEM AND METHOD FOR FULLY CONFIGURABLE REAL TIME PROCESSING, which is a continuation of PCT/IB2015/001288, filed on May 21, 2015, both of which are incorporated by reference in their entirety.

The present disclosure describes various embodiments of a neutral input/output (NIO) platform that includes a core that supports one or more services. While the platform itself may technically be viewed as an executable application in some embodiments, the core may be thought of as an application engine that runs task specific applications called services. The services are constructed using defined templates that are recognized by the core, although the templates can be customized to a certain extent. The core is designed to manage and support the services, and the services in turn manage blocks that provide processing functionality to their respective service. Due to the structure and flexibility of the runtime environment provided by the NIO platform's core, services, and blocks, the platform is able to asynchronously process any input signal from one or more sources in real time.

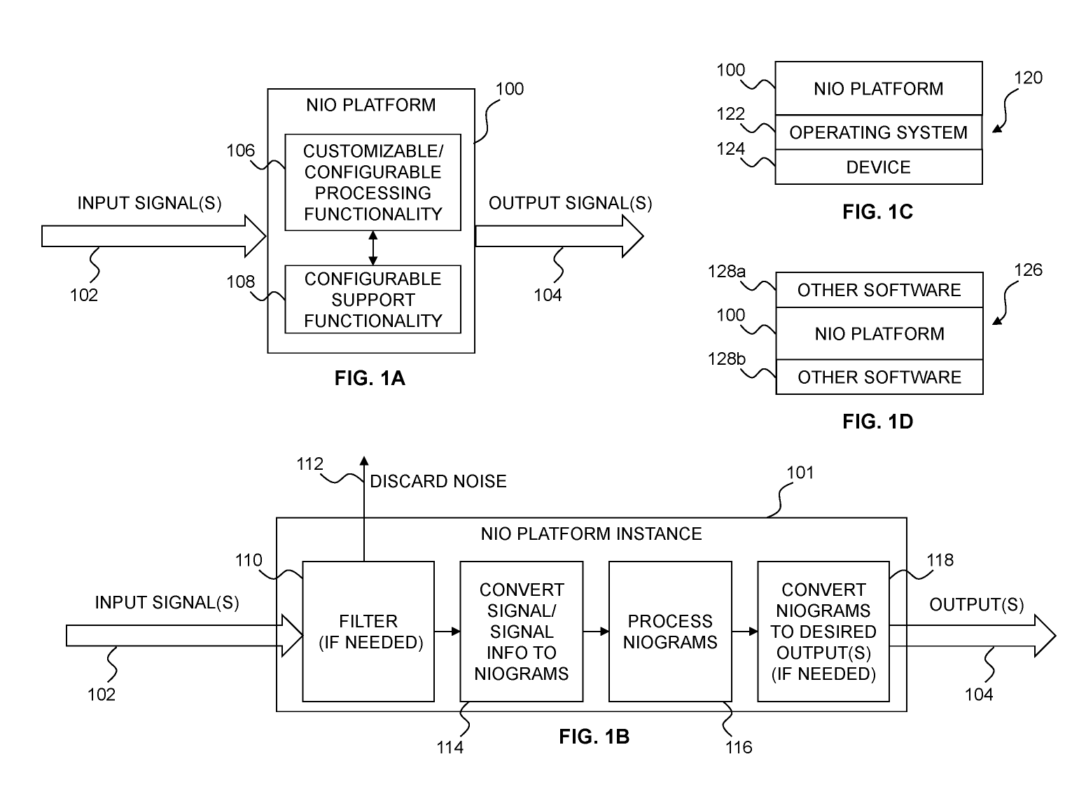

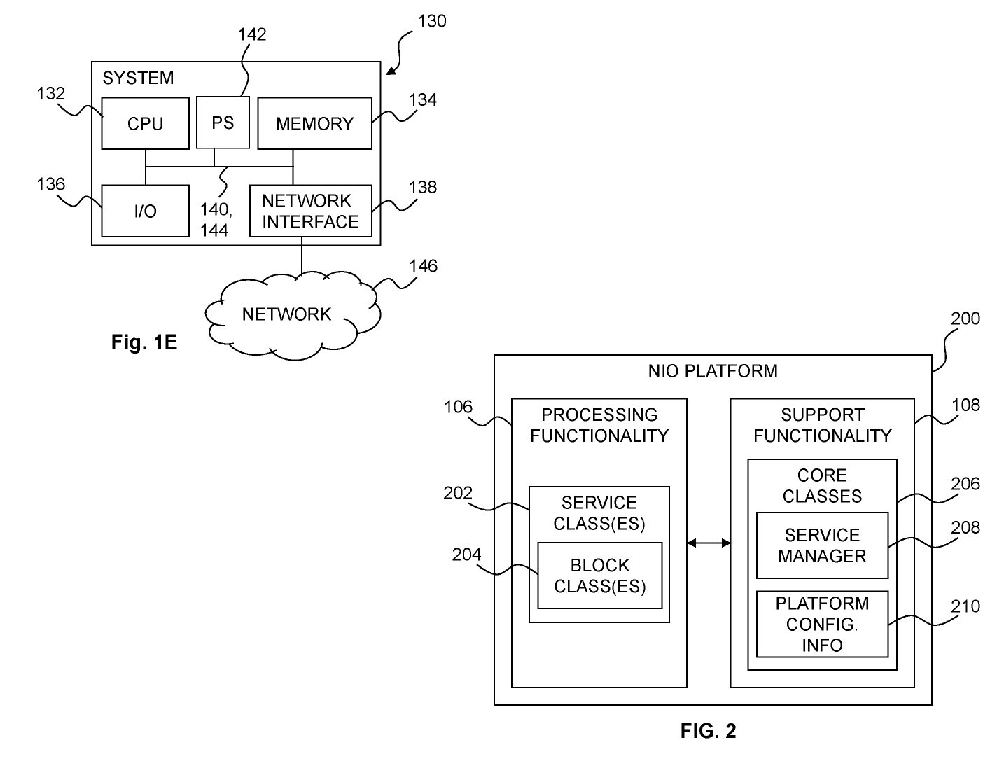

Referring to FIG. 1A, one embodiment of a NIO platform 100 is illustrated. The NIO platform 100 is configurable to receive any type of signal (including data) as input, process those signals, and produce any type of output. The NIO platform 100 is able to support this process of receiving, processing, and producing in real time or near real time. The input signals can be streaming or any other type of continuous or non-continuous input.

When referring to the NIO platform 100 as performing processing in real time and near real time, it means that there is no storage other than possible queuing between the NIO platform instance's input and output. In other words, only processing time exists between the NIO platform instance's input and output as there is no storage read and write time, even for streaming data entering the NIO platform 100.

It is noted that this means there is no way to recover an original signal that has entered the NIO platform 100 and been processed unless the original signal is part of the output or the NIO platform 100 has been configured to save the original signal. The original signal is received by the NIO platform 100, processed (which may involve changing and/or destroying the original signal), and output is generated. The receipt, processing, and generation of output occurs without any storage other than possible queuing. The original signal is not stored and deleted, it is simply never stored. The original signal generally becomes irrelevant as it is the output based on the original signal that is important, although the output may contain some or all of the original signal. The original signal may be available elsewhere (e.g., at the original signal's source), but it may not be recoverable from the NIO platform 100.

It is understood that the NIO platform 100 can be configured to store the original signal at receipt or during processing, but that is separate from the NIO platform's ability to perform real time and near real time processing. For example, although no long term (e.g., longer than any necessary buffering) memory storage is needed by the NIO platform 100 during real time and near real time processing, storage to and retrieval from memory (e.g., a hard drive, a removable memory, and/or a remote memory) is supported if required for particular applications.

The internal operation of the NIO platform 100 uses a NIO data object (referred to herein as a niogram). Incoming signals 102 are converted into niograms at the edge of the NIO platform 100 and used in intra-platform communications and processing. This allows the NIO platform 100 to handle any type of input signal without needing changes to the platform's core functionality. In embodiments where multiple NIO platforms are deployed, niograms may be used in inter-platform communications.

The use of niograms allows the core functionality of the NIO platform 100 to operate in a standardized manner regardless of the specific type of information contained in the niograms. From a general system perspective, the same core operations are executed in the same way regardless of the input data type. This means that the NIO platform 100 can be optimized for the niogram, which may itself be optimized for a particular type of input for a specific application.

The NIO platform 100 is designed to process niograms in a customizable and configurable manner using processing functionality 106 and support functionality 108. The processing functionality 106 is generally both customizable and configurable by a user. Customizable means that at least a portion of the source code providing the processing functionality 106 can be modified by a user. In other words, the task specific software instructions that determine how an input signal that has been converted into one or more niograms will be processed can be directly accessed at the code level and modified. Configurable means that the processing functionality 106 can be modified by such actions as selecting or deselecting functionality and/or defining values for configuration parameters. These modifications do not require direct access or changes to the underlying source code and may be performed at different times (e.g., before runtime or at runtime) using configuration files, commands issued through an interface, and/or in other defined ways.

The support functionality 108 is generally only configurable by a user, with modifications limited to such actions as selecting or deselecting functionality and/or defining values for configuration parameters. In other embodiments, the support functionality 108 may also be customizable. It is understood that the ability to modify the processing functionality 106 and/or the support functionality 108 may be limited or non-existent in some embodiments.

The support functionality 108 supports the processing functionality 106 by handling general configuration of the NIO platform 100 at runtime and providing management functions for starting and stopping the processing functionality. The resulting niograms can be converted into any signal type(s) for output(s) 104.

Referring to FIG. 1B, one embodiment of a NIO platform instance 101 illustrates a data path that starts when the input signal(s) 102 are received and continues through the generation of the output(s) 104. The NIO platform instance 101 is created when the NIO platform 100 of FIG. 1A is launched. A NIO platform may be referred to herein as a “NIO platform” before being launched and as a “NIO platform instance” after being launched, although the terms may be used interchangeably for the NIO platform after launch. As described above, niograms are used internally by the NIO platform instance 101 along the data path.

In the present example, the input signal(s) 102 may be filtered in block 110 to remove noise, which can include irrelevant data, undesirable characteristics in a signal (e.g., ambient noise or interference), and/or any other unwanted part of an input signal. Filtered noise may be discarded at the edge of the NIO platform instance 101 (as indicated by arrow 112) and not introduced into the more complex processing functionality of the NIO platform instance 101. The filtering may also be used to discard some of the signal's information while keeping other information from the signal. The filtering saves processing time because core functionality of the NIO platform instance 101 can be focused on relevant data having a known structure for post-filtering processing. In embodiments where the entire input signal is processed, such filtering may not occur. In addition to or as alternative to filtering occurring at the edge, filtering may occur inside the NIO platform instance 101 after the signal is converted to a niogram.

Non-discarded signals and/or the remaining signal information are converted into niograms for internal use in block 114 and the niograms are processed in block 116. The niograms may be converted into one or more other formats for the output(s) 104 in block 118, including actions (e.g., actuation signals). In embodiments where niograms are the output, the conversion step of block 118 would not occur.

Referring to FIG. 1C, one embodiment of a stack 120 is illustrated. In the present example, the NIO platform 100 interacts with an operating system (OS) 122 that in turn interacts with a device 124. The interaction may be direct or may be through one or more other layers, such as an interpreter or a virtual machine. The device 124 can be a virtual device or a physical device, and may be standalone or coupled to a network.

Referring to FIG. 1D, another embodiment of a stack 126 is illustrated. In the present example, the NIO platform 100 interacts with a higher layer of software 128a and/or a lower layer of software 128b. In other words, the NIO platform 100 may provide part of the functionality of the stack 126, while the software layers 128a and/or 128b provide other parts of the stack's functionality. Although not shown, it is understood that the OS 122 and device 124 of FIG. 1C may be positioned under the software layer 128b if the software 128b is present or directly under the NIO platform 100 (as in FIG. 1C) if the software layer 128b is not present.

Referring to FIG. 1E, one embodiment of a system 130 is illustrated. The system 130 is one possible example of a portion or all of the device 124 of FIG. 1C. The system 130 may include a controller (e.g., a processor/central processing unit (“CPU”)) 132, a memory unit 134, an input/output (“I/O”) device 136, and a network interface 138. The components 132, 134, 136, and 138 are interconnected by a data transport system (e.g., a bus) 140. A power supply (PS) 142 may provide power to components of the system 130 via a power transport system 144 (shown with data transport system 140, although the power and data transport systems may be separate).

It is understood that the system 130 may be differently configured and that each of the listed components may actually represent several different components. For example, the CPU 132 may actually represent a multi-processor or a distributed processing system; the memory unit 134 may include different levels of cache memory, main memory, hard disks, and remote storage locations; the I/O device 136 may include monitors, keyboards, and the like; and the network interface 138 may include one or more network cards providing one or more wired and/or wireless connections to a network 146. Therefore, a wide range of flexibility is anticipated in the configuration of the system 130, which may range from a single physical platform configured primarily for a single user or autonomous operation to a distributed multi-user platform such as a cloud computing system.

The system 130 may use any operating system (or multiple operating systems), including various versions of operating systems provided by Microsoft (such as WINDOWS), Apple (such as Mac OS X), UNIX, and LINUX, and may include operating systems specifically developed for handheld devices (e.g., iOS, Android, Blackberry, and/or Windows Phone), personal computers, servers, and other computing platforms depending on the use of the system 130. The operating system, as well as other instructions (e.g., for telecommunications and/or other functions provided by the device 124), may be stored in the memory unit 134 and executed by the processor 132. For example, if the system 130 is the device 124, the memory unit 134 may include instructions for providing the NIO platform 100 and for performing some or all of the methods described herein.

The network 146 may be a single network or may represent multiple networks, including networks of different types, whether wireless or wireline. For example, the device 124 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 124 with external devices.

Referring to FIG. 2, a NIO platform 200 illustrates a more detailed embodiment of the NIO platform 100 of FIG. 1A. In the present example, the NIO platform 200 includes two main components: service classes 202 for one or more services that are to provide the configurable processing functionality 106 and core classes 206 for a core that is to provide the support functionality 108 for the services. Each service corresponds to block classes 204 for one or more blocks that contain defined task specific functionality for processing niograms. The core includes a service manager 208 that will manage the services (e.g., starting and stopping a service) and platform configuration information 210 that defines how the NIO platform 200 is to be configured, such as what services are available when the instance is launched.

When the NIO platform 200 is launched, a core and the corresponding services form a single instance of the NIO platform 200. It is understood that multiple concurrent instances of the NIO platform 200 can run on a single device (e.g., the device 124 of FIG. 1C). Each NIO platform instance has its own core and services. The most basic NIO platform instance is a core with no services. The functionality provided by the core would exist, but there would be no services on which the functionality could operate. Because the processing functionality of a NIO platform instance is defined by the executable code present in the blocks and the services are configured as collections of one or more blocks, a single service containing a single block is the minimum configuration required for any processing of a niogram to occur.

It is understood that FIG. 2 illustrates the relationship between the various classes and other components. For example, the block classes are not actually part of the service classes, but the blocks are related to the services. Furthermore, while the service manager is considered to be part of the core for purposes of this example (and so created using the core classes), the core configuration information is not part of the core classes but is used to configure the core and other parts of the NIO platform 200.

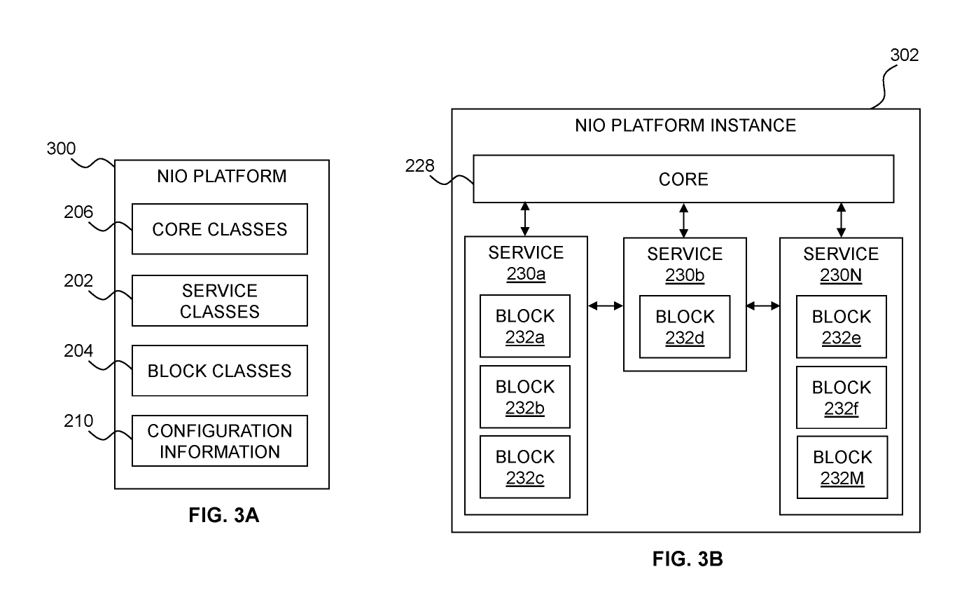

With additional reference to FIGS. 3A and 3B, another embodiment of the NIO platform 200 of FIG. 2 is illustrated as a NIO platform 300 prior to being launched (FIG. 3A) and as a NIO platform instance 302 after being launched (FIG. 3B). FIG. 3A illustrates the NIO platform 300 with core classes 206, service classes 202, block classes 204, and configuration information 210 that are used to create and configure a core 228, services 230a-230N, and blocks 232a-232M of the NIO platform instance 302. It is understood that, although not shown in FIG. 3B, the core classes 206, service classes 202, block classes 204, and configuration information 210 generally continue to exist as part of the NIO platform instance 402.

Referring specifically to FIG. 3B, the NIO platform instance 302 may be viewed as a runtime environment within which the core 228 creates and runs the services 230a, 230b, . . . , and 230N. Each service 230a-230N may have a different number of blocks. For example, service 230a includes blocks 232a, 232b, and 232c. Service 230b includes a single block 232d. Service 230N includes blocks 232e, 232f, . . . , and 232M.

One or more of the services 230a-230N may be stopped or started by the core 228. When stopped, the functionality provided by that service will not be available until the service is started by the core 228. Communication may occur between the core 228 and the services 230a-230N, as well as between the services 230a-230N themselves.

In the present example, the core 228 and each service 230a-230N is a separate process from an operating system/hardware perspective. Accordingly, the NIO platform instance 302 of FIG. 3B would have N+1 processes running, and the operating system may distribute those across multi-core devices as with any other processes. It is understood that the configuration of particular services may depend in part on a design decision that takes into account the number of processes that will be created. For example, it may be desirable from a process standpoint to have numerous but smaller services in some embodiments, while it may be desirable to have fewer but larger services in other embodiments. The configurability of the NIO platform 300 enables such decisions to be implemented relatively easily by modifying the functionality of each service 230a-230N.

In other embodiments, the NIO platform instance 302 may be structured to run the core 228 and/or services 230a-230N as threads rather than processes. For example, the core 228 may be a process and the services 230a-230N may run as threads of the core process.

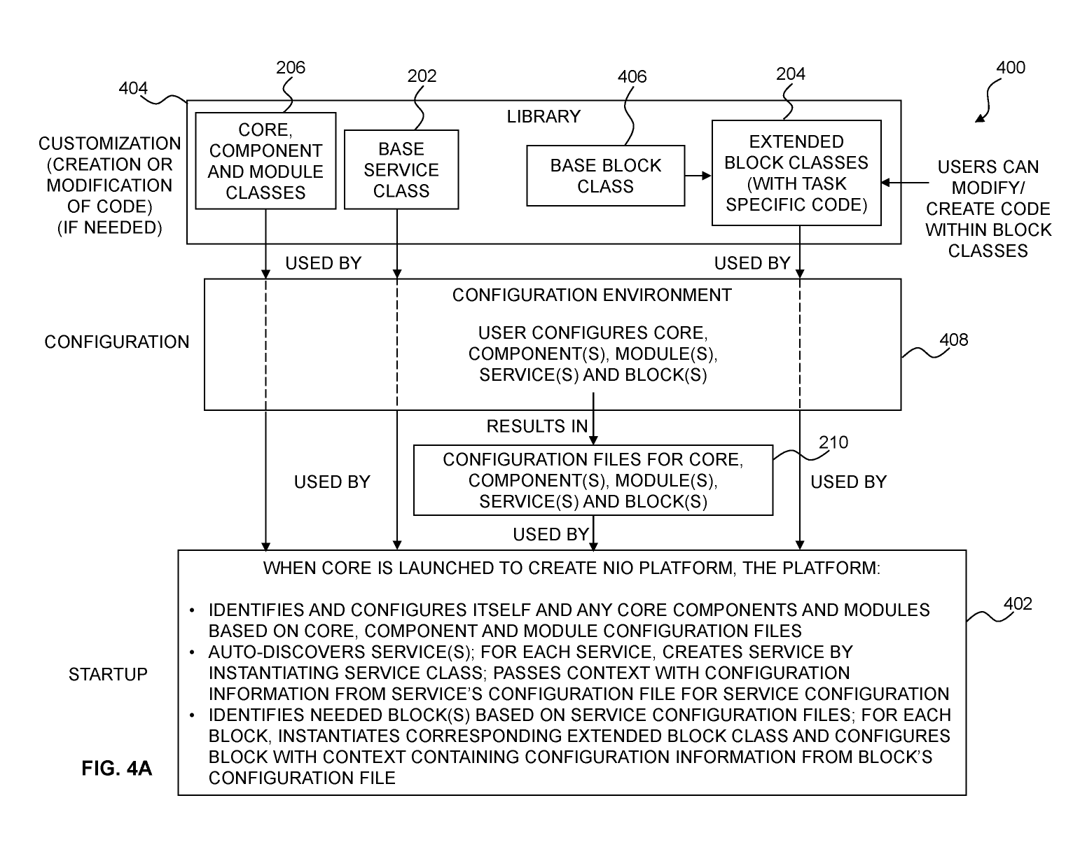

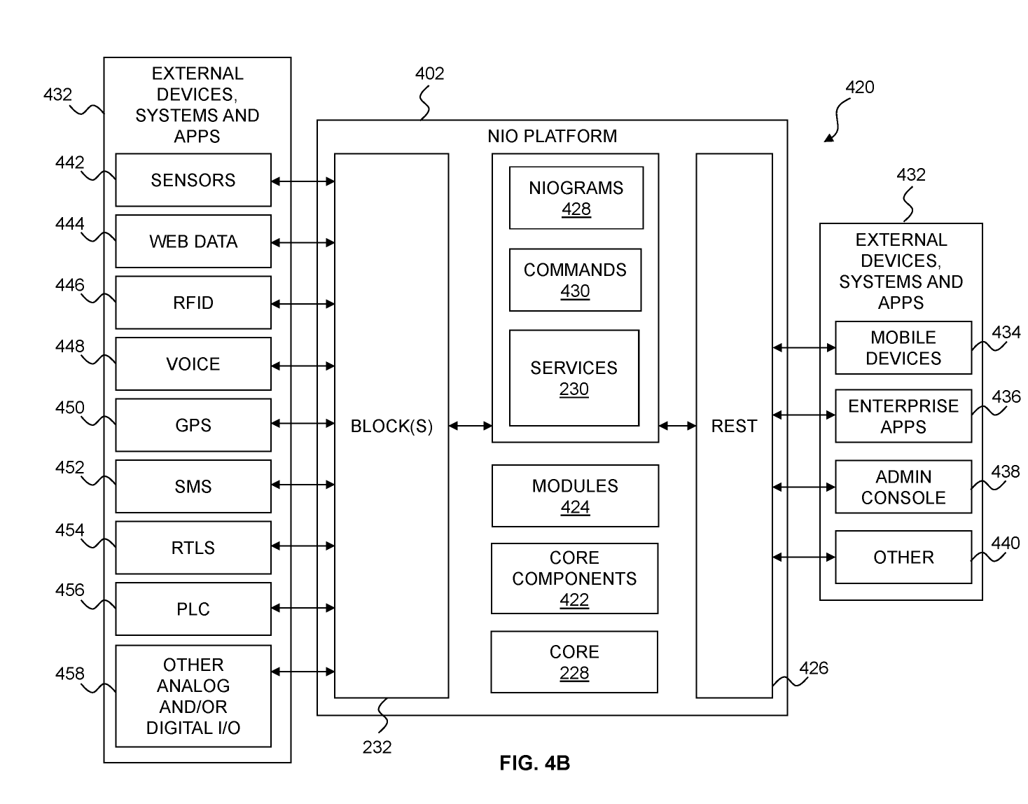

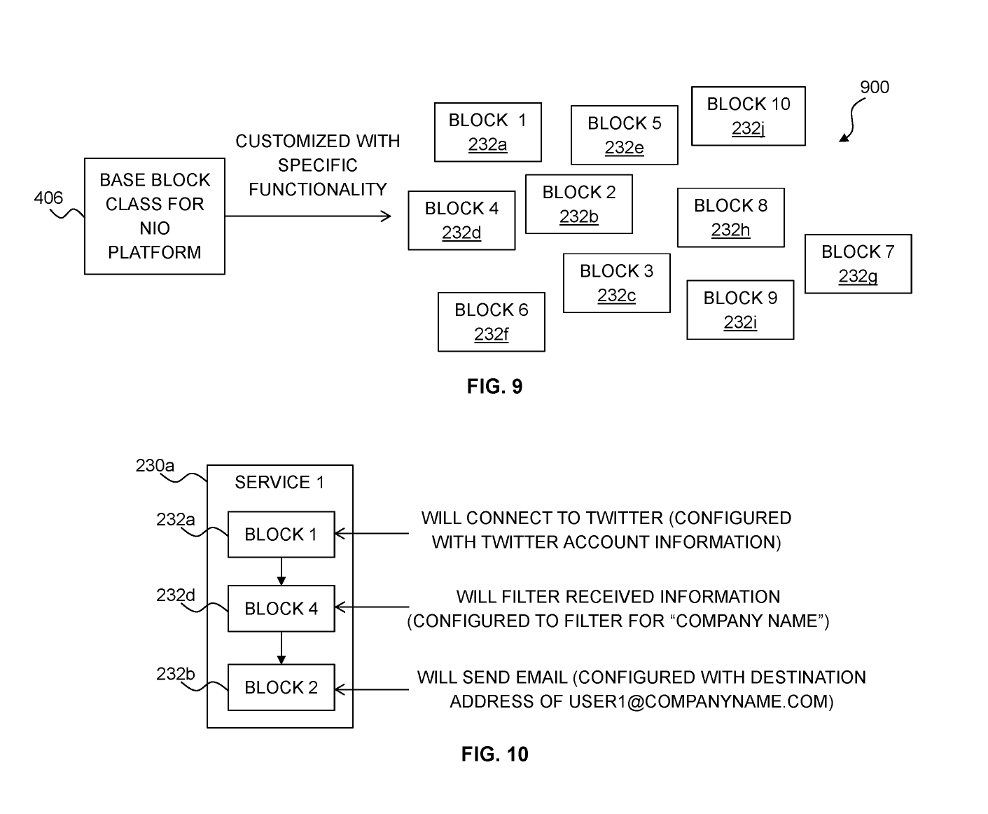

Referring to FIG. 4A, a diagram 400 illustrates one embodiment of a workflow that runs from creation to launch of a NIO platform 402 (which may be similar or identical to the NIO platform 100 of FIG. 1A, 200 of FIG. 2, and/or 300/302 of FIGS. 3A and 3B, as well as 900 of FIGS. 9A and 9B of previously referenced U.S. patent application Ser. No. 14/885,629). The workflow begins with a library 404. The library 404 includes core classes 206 (that include the classes for any core components and modules in the present example), a base service class 202, a base block class 406, and block classes 204 that are extended from the base block class 406. Each extended block class 204 includes task specific code. A user can modify and/or create code for existing blocks classes 204 in the library 404 and/or create new block classes 204 with desired task specific functionality. Although not shown, the base service class 202 can also be customized and various extended service classes may exist in the library 404.

The configuration environment 408 enables a user to define configurations for the core classes 206, the service class 202, and the block classes 204 that have been selected from the library 404 in order to define the platform specific behavior of the objects that will be instantiated from the classes within the NIO platform 402. The NIO platform 402 will run the objects as defined by the architecture of the platform itself, but the configuration process enables the user to define various task specific operational aspects of the NIO platform 402. The operational aspects include which core components, modules, services and blocks will be run, what properties the core components, modules, services and blocks will have (as permitted by the architecture), and when the services will be run. This configuration process results in configuration files 210 that are used to configure the objects that will be instantiated from the core classes 206, the service class 202, and the block classes 204 by the NIO platform 402.

In some embodiments, the configuration environment 408 may be a graphical user interface environment that produces configuration files that are loaded into the NIO platform 402. In other embodiments, the configuration environment 408 may use a REST interface (such as the REST interface 908, 964 disclosed in FIGS. 9A and 9B of previously referenced U.S. patent application Ser. No. 14/885,629) of the NIO platform 402 to issue configuration commands to the NIO platform 402. Accordingly, it is understood that there are various ways in which configuration information may be created and produced for use by the NIO platform 402.

When the NIO platform 402 is launched, each of the core classes 206 are identified and corresponding objects are instantiated and configured using the appropriate configuration files 210 for the core, core components, and modules. For each service that is to be run when the NIO platform 402 is started, the service class 202 and corresponding block classes 204 are identified and the services and blocks are instantiated and configured using the appropriate configuration files 210. The NIO platform 402 is then configured and begins running to perform the task specific functions provided by the services.

Referring to FIG. 4B, one embodiment of an environment 420 illustrates a user's perspective of the NIO platform 402 of FIG. 4A with external devices, systems, and applications 432. From the user's perspective, much of the functionality of the core 228, which may include core components 422 and/or modules 424, is hidden. Various core components 422 and modules 424 are discussed in greater detail in previously referenced U.S. patent application Ser. No. 14/885,629 and are not described further in the present example. The user has access to some components of the NIO platform 402 from external devices, systems, and applications 432 via a REST API 426. The external devices, systems, and applications 432 may include mobile devices 434, enterprise applications 436, an administration console 438 for the NIO platform 402, and/or any other external devices, systems, and applications 440 that may access the NIO platform 402 via the REST API.

Using the external devices, systems, and applications 432, the user can issue commands 430 (e.g., start and stop commands) to services 230, which in turn either process or stop processing niograms 428. As described above, the services 230 use blocks 232, which may receive information from and send information to various external devices, systems, and applications 432. The external devices, systems, and applications 432 may serve as signal sources that produce signals using sensors 442 (e.g., motion sensors, vibration sensors, thermal sensors, electromagnetic sensors, and/or any other type of sensor), the web 444, RFID 446, voice 448, GPS 450, SMS 452, RTLS 454, PLC 456, and/or any other analog and/or digital signal source 458 as input for the blocks 232. The external devices, systems, and applications 432 may serve as signal destinations for any type of signal produced by the blocks 232, including actuation signals. It is understood that the term “signals” as used herein includes data.

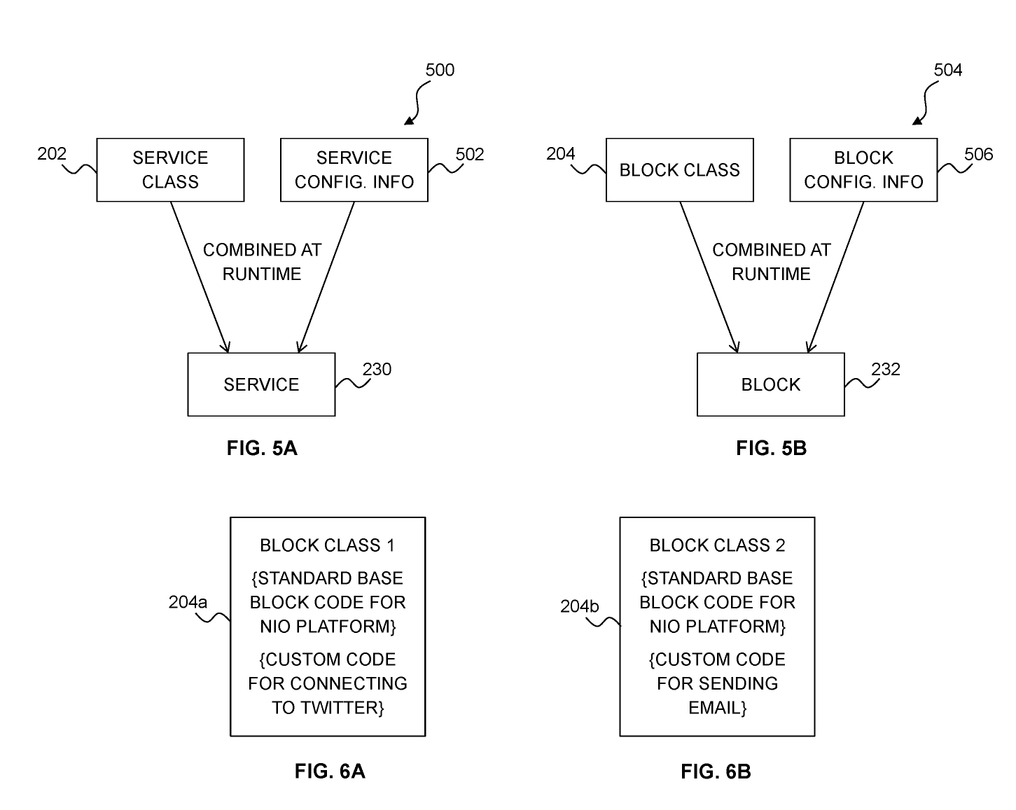

Referring to FIG. 5A, one embodiment of a service configuration environment 500 within which a service 230 is configured at runtime is illustrated. Within the NIO platform 402, each service 230 is created using a class file 202 and configuration information 502. The configuration information includes predefined information that exists before runtime (e.g., as part of the platform configuration information 210 of FIG. 2A) and information that is dynamically generated at runtime. The dynamically generated information is not known until the NIO platform 402 is launched.

The class file 202 may be used by multiple services, but the configuration information 502 is unique to the particular service 230 being created. The configuration information 502 may be in a separate file for each service 230 or may be in a larger file from which a particular service's configuration information is extracted. At runtime, the class file 202 is instantiated and then the configuration information 502 is applied to the instantiated service object.

Referring to FIG. 5B, one embodiment of a block configuration environment 504 within which a block 232 is configured at runtime is illustrated. Within the NIO platform 402, each block 232 is created using a class file 204 and configuration information 506. The configuration information includes predefined information that exists before runtime (e.g., as part of the platform configuration information 210 of FIG. 2A) and information that is dynamically generated at runtime. The dynamically generated information is not known until the NIO platform 402 is launched.

The class file 204 may be used by multiple blocks, but the configuration information 506 is unique to the particular block 232 being created. The configuration information 506 may be in a separate file for each block 232 or may be in a larger file from which a particular block's configuration information is extracted. At runtime, the class file 204 is instantiated and then the configuration information 506 is applied to the instantiated block object.

Referring to FIGS. 6A and 6B, embodiments of class files 204a and 204b for blocks 232a and 232b (not shown), respectively, are illustrated. Within the NIO platform 402, the service class files 202 and block class files 204 are based on a base service template (for services 230) and a base block template (for blocks 232), respectively. These base templates include NIO platform specific behavior that is inherited by any class that extends them. This means that each service class 202 and block class 204 inherits NIO platform specific behavior that allows the corresponding service 230 or block 232 to work within the NIO platform architecture. Without this NIO platform specific behavior, the class files 202 and 204 would not be recognized within the NIO platform architecture and so the corresponding services 230 and classes 232 could not be created. In addition to the NIO platform specific behavior, each block class 204 contains executable instructions that provide particular task specific functionality.

Referring specifically to FIG. 6A, the class file 204a for Block Class 1 includes the standard base block code for the NIO platform and also contains custom code for connecting to an external signal source, which is Twitter for purposes of example. Referring specifically to FIG. 6B, the class file 204b for Block Class 2 includes the standard base block code for the NIO platform and also contains custom code for sending email.

If there is not an existing block class that contains the code needed to perform a particular task, either a new block class can be created using the base block template or an existing block class 204 can be modified. While service classes 202 can also include custom code, they rarely do so because the base service template generally provides all the functionality needed for a service 230. However, it is understood that service classes 202 can also be customized.

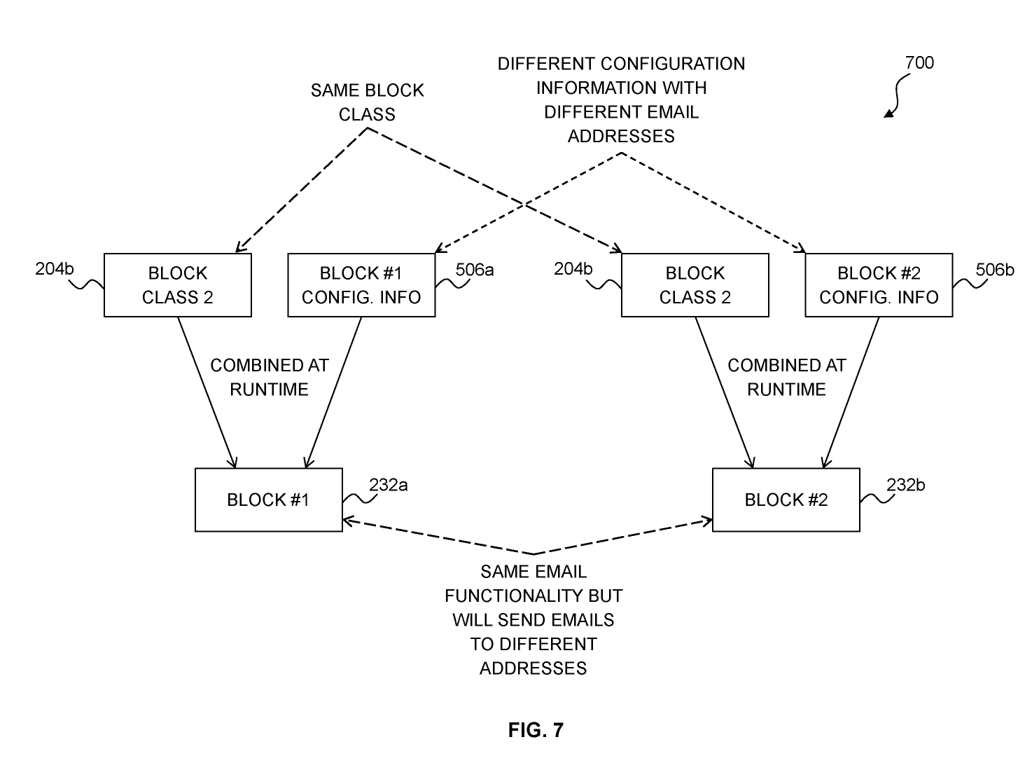

Referring to FIG. 7, one embodiment of an environment 700 within which configuration information is used to configure two blocks 232 based on the same block class 204 in different ways is illustrated. The configuration information 506 (FIG. 5B) allows configuration of a particular block 232 at runtime by setting the values of configurable parameters defined within the block class 204. This means that the same block 232 can be configured in different ways depending on the values in the configuration information 506 that is used to configure the block 232.

The block class 204b (as shown in FIG. 6B) contains custom code to send any information received by the block 232 to a destination email address. The code includes a configurable parameter for the destination email address to avoid having to change the underlying block class 204 each time a different email address is used. This allows the email address to be defined in the configuration information 506, which means that the same block class 204 can be used to create multiple blocks that send their emails to different addresses.

Accordingly, in the present example, the block class 204b is to be used to instantiate two blocks 232a (also referred to as Block #1) and 232b (also referred to as Block #2). The blocks 232a and 232b are to be configured to send email to two different addresses using configuration information 506a (also referred to as Block #1 configuration information) and 506b (also referred to as Block configuration information #2), respectively. When the blocks 232a and 232b are instantiated and configured, the two blocks will have the same email sending functionality, but will send their emails to different email addresses.

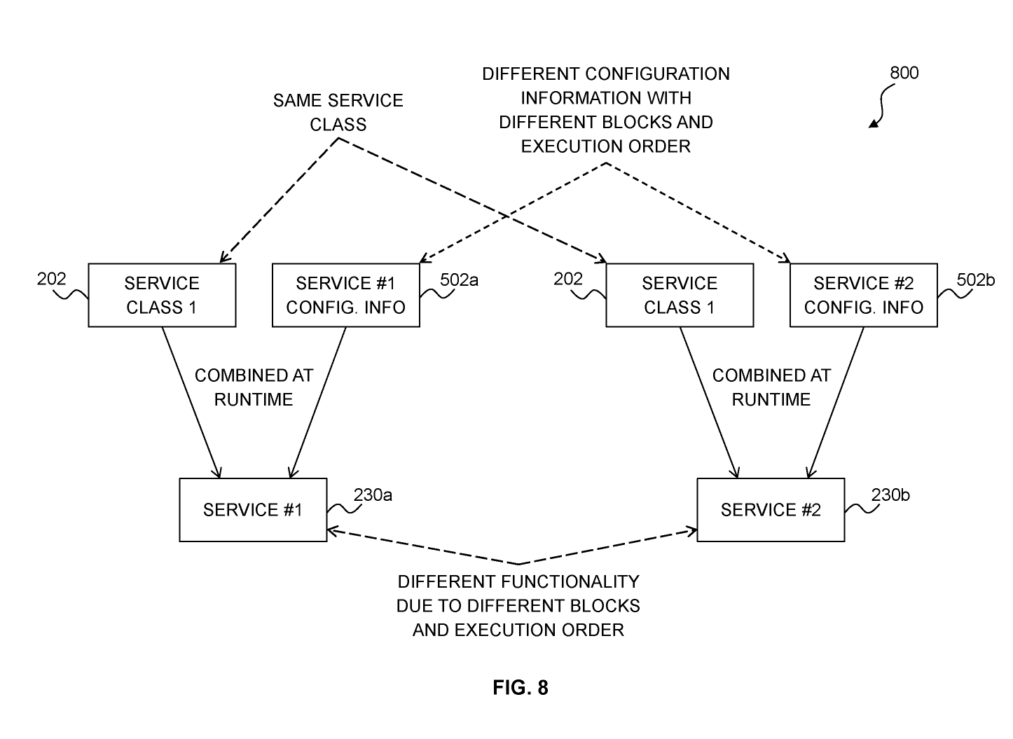

Referring to FIG. 8, one embodiment of an environment 800 within which configuration information is used to configure two services 230 based on the same service class 202 in different ways is illustrated. The configuration information 502 (FIG. 5A) allows limited configuration of a particular service 230 at runtime by defining which blocks 232 are to be executed by the service and the order of execution of the blocks 232. The configuration information 502 may also be used to set the values of configurable parameters defined within the service class 202. This means that the same service 230 can be configured in different ways depending on the blocks 232, the order of execution, and the values in the configuration information 502 that is used to configure the service 230.

In the present example, the configuration information 502 for a service 230 includes source blocks and destination blocks needed to build a routing table when the service 230 is instantiated. Because the blocks 232 do not have any connection to each other except through the service 230, the service 230 uses the routing table to direct information from one block (a source block) to the next block (a destination block). The service 230 receives the source and destination blocks as configuration information after the service 230 is instantiated, so the same underlying service class 202 can be used for different services 230. This means that the services 230 can have different functionality based on the particular blocks 232 and block execution order defined in their configuration information 502.

Accordingly, in the present example, a service class 202 is to be used to instantiate two services 230a (also referred to as Service #1) and 230b (also referred to as Service #2). The services 230a and 230b are to be configured using different blocks and different orders of execution using configuration information 502a (also referred to as Service #1 configuration information) and 502b (also referred to as Service #2 configuration information), respectively. When the services 230a and 230b are instantiated and configured, the two services will have different functionality.

In the present example, the fact that a service 230 is made up of a service class 202 and configuration information 502 means that, prior to instantiation, there is no service class 202 that can be examined to determine the execution order of blocks 232, or even the blocks 232 that are to be used, within the service 230. To determine the behavior of the service 230, the configuration information 502 would have to be examined.

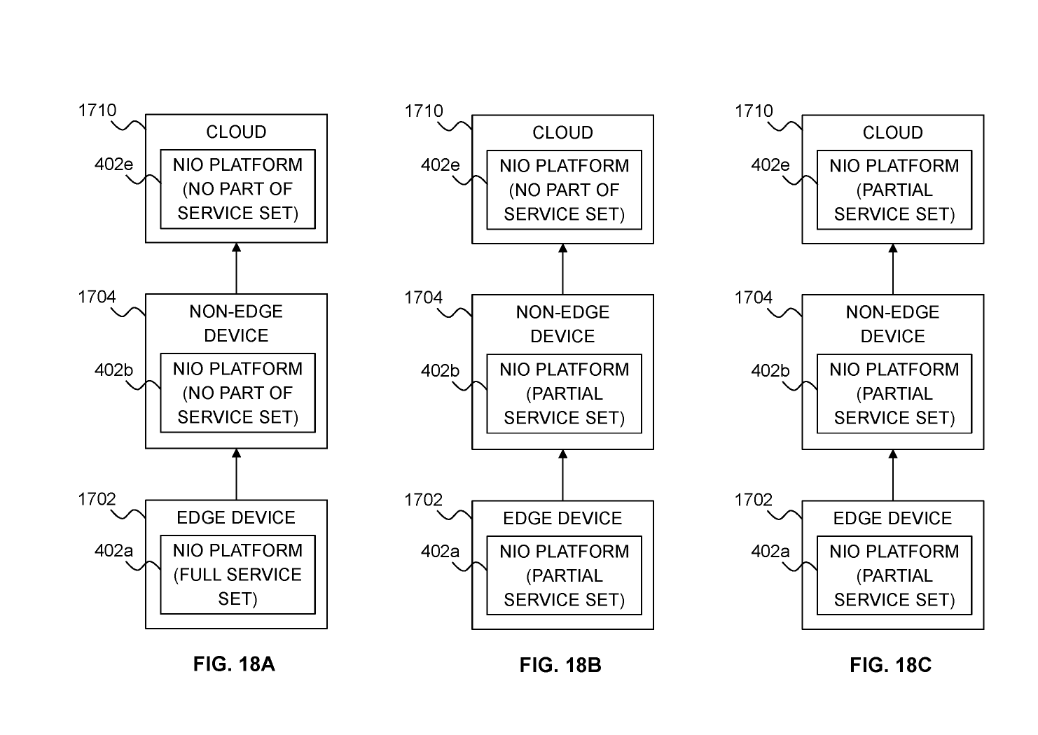

Referring to FIG. 9, one embodiment of an environment 900 is illustrated with a base block class 1806 that is extended to create various customized block classes (not shown), such as those in the library 1804 of FIG. 18. The customized block classes can then be instantiated as described previously to form various blocks 232a-232j. As described above, a NIO platform operates by using a service 230 to organize the appropriate blocks 232 to perform a particular task. In the present example, the blocks 232 do not have any connection to each other except through the service 230. This organizational structure provides benefits such as asynchronicity in block execution, dynamic expansion and retraction of block resources in response to input changes, and the ability to modify services 230 and blocks 232 without having to restart the NIO platform 402.

For example, as shown in FIG. 9, the environment 900 includes a block library that contains the ten blocks 232a-232j. Each of the blocks 232a-232j is built from the base block template, so each block is compatible with the NIO platform architecture. The blocks 232a-232j have no connection to each other except that all of them can operate within the NIO platform architecture. Each block 232a-232j contains task specific code that allows that block to perform a particular function. For example, the block 232a connects to Twitter, the block 232b sends an email containing any information received from another block, the block 232c connects to a machine in an assembly line, the block 232d filters any input received from another block for one or more defined text strings, the block 232e sends a signal to turn off the machine on the assembly line, and so on.

Assume that a user wants to create two different services 230a and 230b using the ten blocks 232a-232j. Service 230a is to monitor an external source (e.g., Twitter) Twitter for the words “company name” and send an email to user1@companyname.com if such a tweet is detected. Service 230b will monitor an assembly line machine for the occurrence of certain error codes and send an email to user2@companyname.com if an error is detected. Service 230b will also shut the machine down if an error is detected. Services 230a and 230b are to run simultaneously on a single NIO platform and perform their tasks asynchronously and in real time without any data storage.

With additional reference to FIG. 10, one embodiment of the service 230a is illustrated using blocks from the environment 900 of FIG. 9. Service 230a is created by identifying the needed block classes and defining their order of execution. For example, the block 232a (connecting to Twitter) will be followed by the block 232d (filtering for “company name”), and then the block 232b will send an email to user1@companyname if block 232d identifies any tweets with “company name.” The block classes include configurable parameters that allow them to be customized without needing to open the block classes and change their code. FIG. 10 illustrates the configured appearance of the service 230a from a functional perspective.

The routing table for the service 230a defines the destination block for any output from a source block. If a block does not send output to another block (i.e., the block 232b), there is no entry in the routing table. There is no source block for block 232a because block 232a is connecting directly to Twitter. Table 1 illustrates an example of a routing table for the service 230a.

TABLE 1
Service 230a

| Source Block | Destination Block |
|---|---|
| Block 232a | Block 232d |
| Block 232d | Block 232b |

The decoupled nature of the blocks and the flexibility provided by the routing table allow the service 230a to be modified or blocks swapped for other blocks relatively easily. It is understood that any configuration changes and any new blocks must be loaded into the NIO platform (assuming the new blocks are not already there) and then the service 230a must be restarted for changes to take effect. For example, if a user wants to swap the email block 232b for a text message block, block 232b can be replaced with a suitably configured block for sending texts. If the block's name remains the same, the routing table may not even change in some embodiments. If the block's name is different, the routing table needs to be updated, but no other change may be needed. Table 2 illustrates an example of the routing table for the service 230a with the block 232b replaced by a text message block 232g.

TABLE 2
Service 230a

| Source Block | Destination Block |
|---|---|
| Block 232a | Block 232d |
| Block 232d | Block 232g |

If the user wants to send both the text message and the email, then the text message block 232g can be added so that it exists within the service 230a alongside the email block 232b. In this case, the routing table can be updated to include the new block 232g as another destination for source block 232d. Table 3 illustrates an example of the routing table for the service 230a with both block 232a and block 232g.

TABLE 3
Service 230a

| Source Block | Destination Block |
|---|---|
| Block 232a | Block 232d |
| Block 232d | Block 232b, 232g |

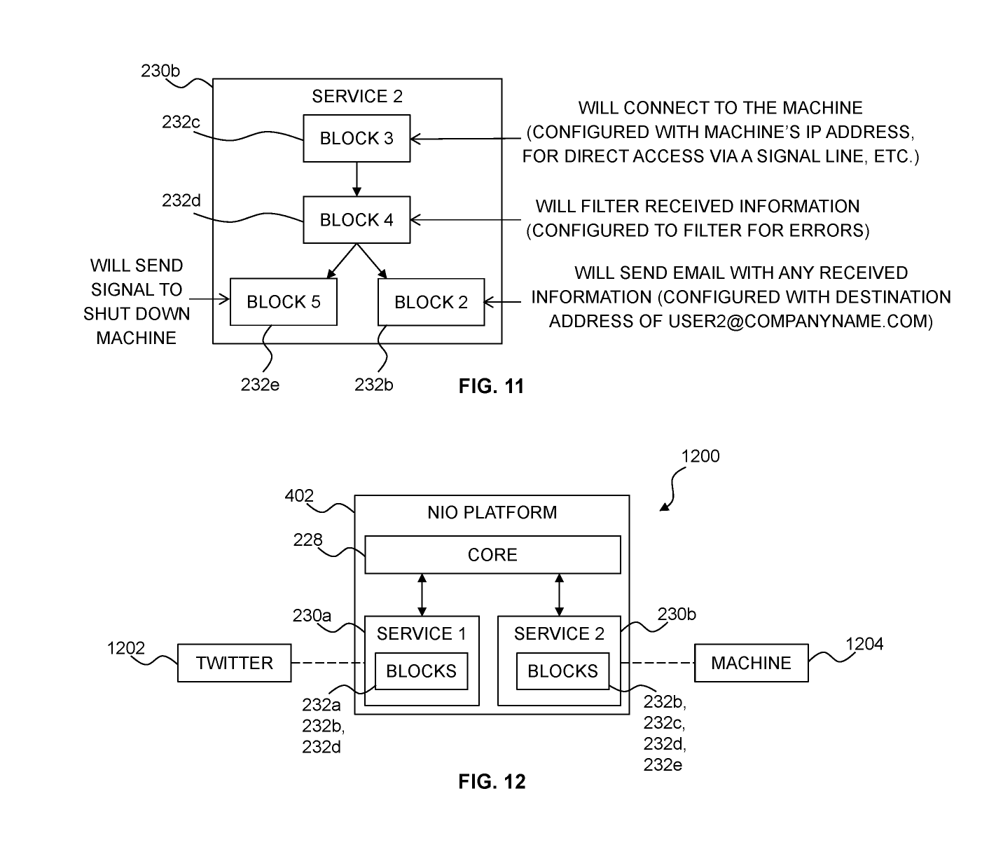

With additional reference to FIG. 11, one embodiment of the service 230b is illustrated using blocks from the environment 900 of FIG. 9. Service 230b is created by identifying the needed block classes and defining their order of execution. For example, the block 232c (connecting to the machine) will be followed by the block 232d (filtering against an error list). If an error is detected, the block 232b will send an email to user2@companyname and the block 232e will shut down the machine. The block classes include configurable parameters that allow them to be customized without needing to open the block classes and change their code. FIG. 11 illustrates the configured appearance of the service 230b from a functional perspective. Table 4 illustrates an example of a routing table for the service 232b.

TABLE 4
Service 230b

| Source Block | Destination Block |
|---|---|
| Block 232c | Block 232d |
| Block 232d | Block 232b, 232e |

Referring to FIG. 12, one embodiment of the NIO platform 402 is shown within an environment 1200. The environment 1200 includes access to Twitter 1202 and a machine 1204. As shown, the NIO platform 402 includes a core 228 and is running the two services 230a and 230b simultaneously. Each service 230a and 230b performs its configured functions independently of the other service.

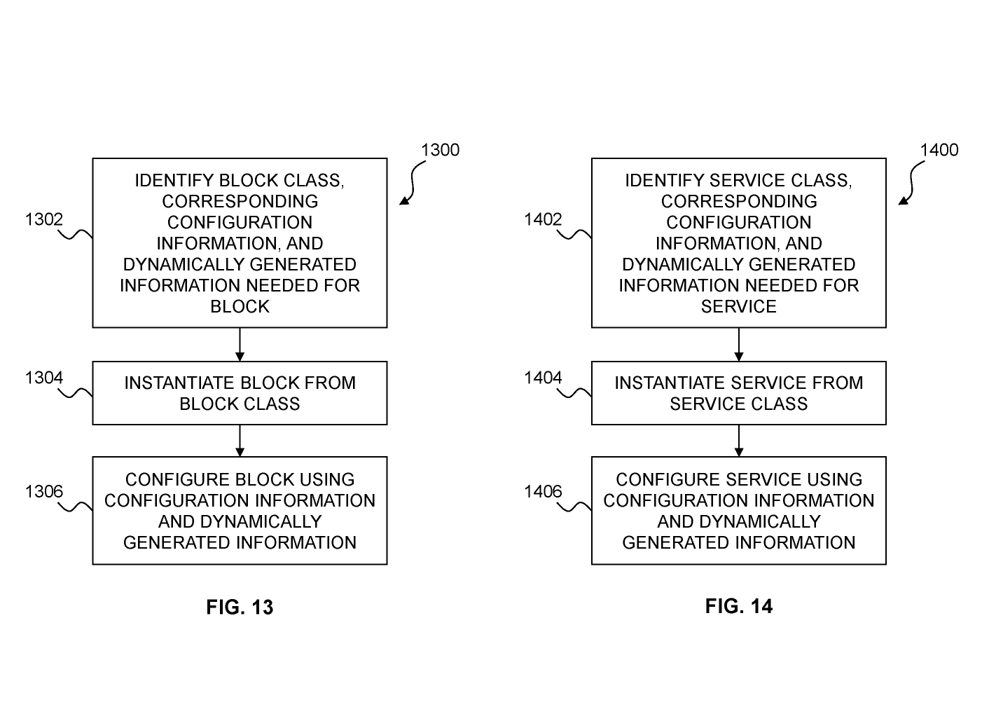

Referring to FIG. 13, a method 1300 illustrates one embodiment of a process that may be executed by the NIO platform of FIG. 12 to create and configure a block 232. In step 1302, a block class 204 is identified along with the block's corresponding configuration information and dynamically generated information needed for the block 232. In step 1304, the block 232 is instantiated from the block class 204. In step 1306, the block 232 is configured using the corresponding configuration information and dynamically generated information.

Referring to FIG. 14, a method 1400 illustrates one embodiment of a process that may be executed by the NIO platform of FIG. 12 to create and configure a service 230. In step 1402, a service class 202 is identified along with the service's corresponding configuration information and dynamically generated information needed for the service 230. In step 1404, the service 230 is instantiated from the service class 202. In step 1406, the service 230 is configured using the corresponding configuration information and dynamically generated information.

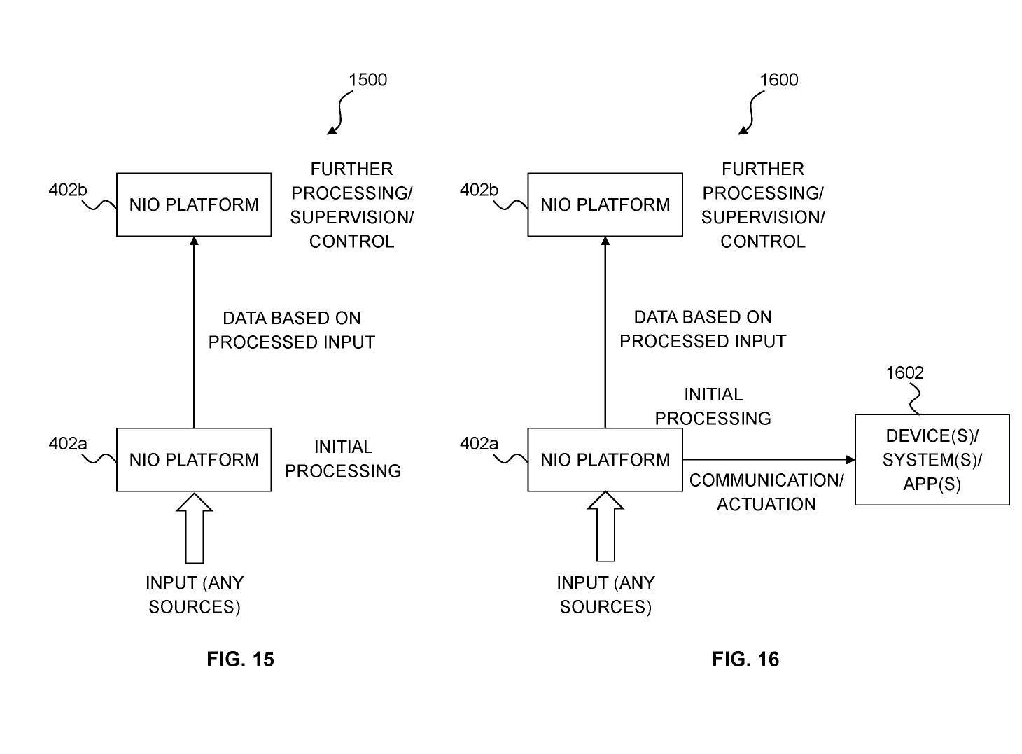

Referring to FIG. 15, one embodiment of a system 1500 illustrates two NIO platforms 402a and 402b organized in a tiered or hierarchical arrangement within which real time processing can be performed. Within the system 1500, the NIO platform 402a feeds into the NIO platform 402b. Although not shown, it is understood that the communications may be two way, with each of the NIO platforms 402a and 402b sending information (e.g., data and/or commands) to and receiving information from the other of the NIO platforms. For purposes of example, the NIO platform 402a is on an edge device for the system 1500 and the NIO platform 402b is not on an edge device.

As described in previous embodiments, each NIO platform 402a and 402b uses the same basic core 228, but can be configured with different core components 912, modules 904, and/or services 230 with corresponding blocks 232. This configurability enables the NIO platform to serve as a single platform solution for the system 1500 while supporting highly flexible distribution of the system's processing capabilities. For example, depending on which of the NIO platforms 402a and 402b is selected to run a particular service, particular processing functionality in the system 1500 can be moved out to the edge or moved away from the edge as desired. Accordingly, the NIO platform can be used in multiple locations of the system 1500 and the functionality of a particular one of the NIO platforms within the system 1500 can be configured as desired.

By deploying the NIO platform 402a on an edge device, the fully configurable processing provided by the NIO platform 402a can be used to reduce and/or eliminate the need to transfer data for decision making to another device (e.g., a device on which the NIO platform 402b is running). This not only reduces network traffic, but also means that decisions can be made more quickly as the NIO platform 402a operating at the edge can be configured to make decisions and act on those decisions without the additional temporal overhead that would be required for the round trip transmission time that would be imposed by communications with the NIO platform 402b located on another device. If needed or desired, data can be transferred away from the edge and deeper into the system 1500.

The configurability of the NIO platforms 402a and 402b in the system 1500 may reduce and/or eliminate the need for customized hardware and/or software needed for particular tasks. The development of such hardware/software is often an expensive and time consuming task, and the development cycle may have to be repeated for each particular device that is to be integrated into or coupled to the system 1500. For example, a particular server application may need to interact with different interfaces and/or different operating system running on different devices, and so multiple versions of the same software may be created.

In contrast, because the NIO platform can be configured as desired, adapting a particular service to another interface may be as simple as exchanging one block for another block and setting some configuration values. Furthermore, even though the services can be completely different on different NIO platforms, the use of a standard interface across the NIO platforms provides a consistent environment to users regardless of the services to be run. This enables a user familiar with the interface to configure a NIO platform for its particular task or tasks relatively easily.

Furthermore, because blocks can be reused and existing blocks can be modified, creating a service for a particular task may leverage existing assets. If new blocks are created, they can be used in other instances of the NIO platform. Therefore, each deployment of a particular configuration of the NIO platform 402 may result in a larger library of blocks, which in turn may lessen the amount of effort required for the next deployment. This is particularly true in cases where the next deployment has substantial similarities to the current deployment, such as deployments in different locations that perform similar or identical operations (e.g., manufacturing or agriculture operations).

Accordingly, the NIO platform 402a receives external input that may be any type(s) of input for which the NIO platform 402a is configured. The external input comes from one or more external devices, systems, and/or applications (not shown). As the NIO platform 402a is an edge device in the present example, the input will not be exclusively from another NIO platform, although some of the input may be from another NIO platform. The NIO platform 402a processes the input and then passes data based on the processed input to the NIO platform 402b. Depending on the configuration of the NIO platform 402a, the processing can range from simple (e.g., simply inserting the input into a niogram for forwarding) to complex (e.g., executing multiple related services with complex instructions). The NIO platform 402b can then perform further processing if needed.

This tiered system enables the NIO platform 402a to perform its functions at the point of input into the system 1500, rather than having to pass the input to the NIO platform 402b for processing. When the NIO platform 402a is located on an edge device, this means that the input can be processed at the edge based on the particular configuration of the NIO platform 402a.

Referring to FIG. 16, one embodiment of a system 1600 illustrates the two NIO platforms 402a and 402b of FIG. 15 and one or more devices, systems, and/or applications 1602. As described with respect to FIG. 15, the NIO platforms 402a and 402b are organized in a tiered arrangement. As shown, the NIO platform 402a is an edge device and can directly actuate the device 1602. This means that the processing performed on the input at the edge, which may include input from the device 1602, can be used to actuate the device 1602 or another device, system, or application. By configuring the services 230 on the NIO platform 402a to handle whatever logic may be desired with respect to the device 1602, the actuation of the device 1602 directly from the NIO platform 402a can occur in real time without introducing additional transmission time.

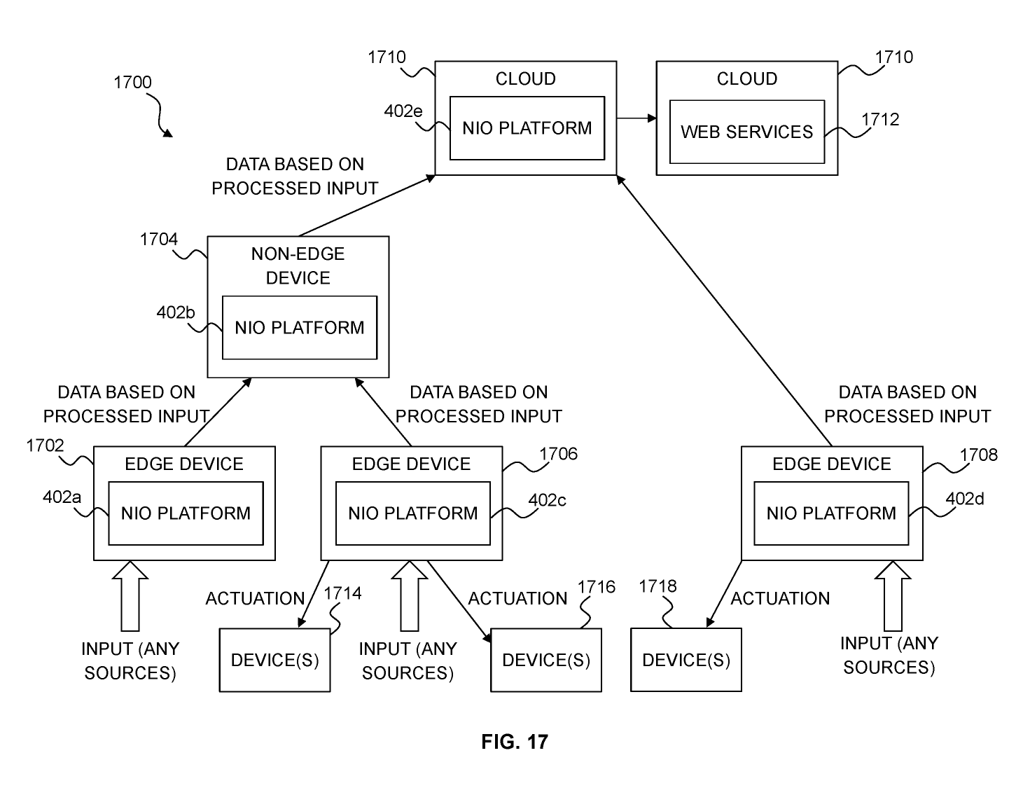

Referring to FIG. 17, one embodiment of a system 1700 illustrates the two NIO platforms 402a and 402b of FIG. 15. The system 1700 also includes additional NIO platforms 402c, 402d, and 402e. The NIO platforms 402a, 402c, and 402d are running on edge devices 1702, 1706, and 1708, respectively. The NIO platform 402b is running on a non-edge device 1704. The NIO platform 402e is running on a server/distributed server system (e.g., a cloud) 1710.

The system 1700 further includes devices 1714, 1716, and 1718 (which may represent one or more devices, systems, and/or applications as shown in FIG. 16), as well as web services 1712 running in the cloud, although these components may not be included in the system itself in embodiments where the NIO platforms are viewed as the system. In some embodiments, some or all of the web services 1712 may be provided by the NIO platform 402e, while in other embodiments the web services 1712 may be separate from the NIO platform 402e.

For purposes of example, the NIO platforms 402a, 402c, and 402d are referred to as being located on edge devices. More specifically, any NIO platform in the present example that is positioned to directly interface with a device other than a NIO platform is referred to as an edge platform or running on an edge device, while any NIO platform that only interfaces with other NIO platforms or the web services 1712 for output is not an edge platform. Although not shown, it is understood that multiple instances of the NIO platform may be run on a single device. For example, the NIO platforms 402a and 402c may be run on one device, rather than on the two devices 1702 and 1706.

The NIO platforms 402a and 402c are configured to receive input from any source(s), process the input, and pass data based on the input to the NIO platform 402b. The NIO platform 402b is configured to process the received input and pass data based on the input to the NIO platform 402e. The NIO platform 402d is configured to receive input from any source(s), process the input, and pass data based on the input to the NIO platform 402e. The NIO platform 402e is configured to process the input and pass data based on the input to the web services 1712 for output as a message (e.g., an email, SMS, or voice message), to a display (e.g., as a webpage), a database, and/or any other destination. It is understood that additional NIO platforms may be present in the system 1700.

The arrows representing communication illustrate the general flow of data “up” through the tiers of the system 1500 and “down” to the devices 1714, 1716, and 1718 for actuation purposes. However, although the communications are illustrated as one way, it is understood that two way communications are likely to occur. For example, the NIO platforms will likely communicate with the NIO platforms at lower levels (e.g., the NIO platform 402e with the NIO platform 402b), and such communications may include configuration changes to the core 228, services 230, or blocks 232 of a particular NIO platform, commands to perform certain actions, actuation commands to be passed through to one of the devices 1714, 1716, or 1718, and/or requests for data. Accordingly, depending on how the NIO platforms 402a-402e are configured and the capabilities of the devices on which the NIO platforms 402a-402e are running, the communications used with the system 1700 may range from the simple to the complex.

FIGS. 18A-18C illustrate embodiments of how a set of services 230 may be assigned to a single NIO platform or distributed among multiple NIO platforms. One advantage provided by using multiple instances of a single configurable platform to form a system such as the system 1700 of FIG. 17 is that the system's functionality may be distributed relatively easily in many different ways simply by configuring the various NIO platforms as desired. It is understood that the service set may actually be a single service, but will often include multiple services that work together to accomplish a particular task. Accordingly, the following examples apply equally to a single service that can be divided into multiple services. The NIO platforms 402a, 402b, and 402e of FIG. 17 are used for purposes of example, with the set of services being responsible for receiving the input, performing defined processing tasks, and then producing a final output.

Referring specifically to FIG. 18A, the entire set of services is located on the NIO platform 402a. In this embodiment, the NIO platform 402a performs all the functions of receiving the input, performing the defined processing tasks, and producing the final output. The final output may include sending an actuation signal to a device, sending data to the NIO platform 402b, or waiting for additional input (e.g., not sending anything out).

Referring specifically to FIG. 18B, the set of services is divided between the NIO platform 402a and the NIO platform 402b. In this embodiment, the NIO platform 402a would be responsible for receiving input. The functions of performing the defined processing tasks and producing the final output may be split between the NIO platforms 402a and 402b in many different ways. For example, the NIO platform 402a may perform part of the processing and send data to the NIO platform 402b. The NIO platform 402b may then perform additional processing and produce the final output.

In another example, the NIO platform 402a would be responsible for receiving input and would simply forward the input data to the NIO platform 402b. The NIO platform 402b would then perform the defined processing tasks and produce the final output. In yet another example, the NIO platform 402a would be responsible for receiving input and would forward the input data to the NIO platform 402b. The NIO platform 402b would then perform the defined processing tasks and send the processed data back to the NIO platform 402a, which would produce the final output.

Referring specifically to FIG. 18C, the set of services is divided among the NIO platform 402a, the NIO platform 402b, and the NIO platform 402e. In this embodiment, the NIO platform 402a would be responsible for receiving input. The functions of performing the defined processing tasks and producing the final output may be split among the NIO platforms 402a, 402b, and 402e in many different ways. For example, the NIO platform 402a may perform part of the processing and send data to the NIO platform 402b. The NIO platform 402b may then perform additional processing and send the processed data to the NIO platform 402e. The NIO platform 402e may perform additional processing and produce the final output or may simply produce the final output with minimal processing.

In another example, the NIO platform 402a would be responsible for receiving input and would forward the input data to the NIO platform 402b. The NIO platform 402b may be configured to process the data and then send the processed data to the NIO platform 402e for the final output. In yet another example, the NIO platform 402a would be responsible for receiving the input and performing initial processing, and would then send the processed data to the NIO platform 402b. The NIO platform 402b may be configured to simply pass the received data on to the NIO platform 402e for further processing and the final output. It is understood that the final output may be produced by any of the NIO platforms 402a, 402b, and 402e and sent to any of the other NIO platforms.

Accordingly, as illustrated by FIGS. 18A-18C, the use of the NIO platform in a multi-tiered arrangement enables services to be distributed as desired. For example, the device 1702 on which the NIO platform 402a is running may have limited processing resources available (e.g., the device 1702 may have limited CPU and/or memory resources), while the device 1704 may have considerably more processing resources. In such an embodiment, the services may be divided so as much processing as possible is performed on the device 1702, and the remainder is moved to the device 1704. In another example, the device 1702 may be capable of performing all the needed processing, and so may be configured to provide all of the processing and the final output. If the device 1702 is capable of performing all the needed processing, configuring it to do so may result in less data being sent to the device 1704, which may lower the amount of bandwidth needed for such data transfers (depending on the output of the NIO platform 402a). This can be particularly beneficial if the amount of bandwidth is relatively limited and/or shared by other devices.

The interchangeability of the NIO platforms, where a primary NIO platform can be replaced by a backup NIO platform with the same configuration, also makes the provision of failover or backup platforms relatively simple. For example, referring again to FIG. 17, the NIO platform 402a may be a backup or failover platform for the NIO platform 402c. In this example, the NIO platform 402a may not have any inputs or may have the exact same inputs as the NIO platform 402c. The NIO platform 402a or the NIO platform 402b would monitor the NIO platform 402c and, if the NIO platform 402c fails or becomes unresponsive, the NIO platform 402a would take over some or all of the functionality provided by the NIO platform 402c.

In another example, the NIO platform 402a may aid the NIO platform 402c if the NIO platform 402c receives an input data surge that it is unable to handle with its current processing capabilities. The NIO platform 402a would handle the overflow processing in such cases. Once the surge subsides, the NIO platform 402c would no longer need help handling the overflow processing and the NIO platform 402a could return to a standby mode.

In another example, the NIO platform 402a may be configured to run services that are also configured to be run on multiple other NIO platforms. This enables the single NIO platform 402a to aid different NIO platforms as the need arises. For example, the NIO platform 402a may be running on a relatively powerful device that matches the processing resources of the other devices on the NIO platforms are running, which in turn enables the NIO platform 402a to aid multiple other NIO platforms simultaneously. This allows a relatively powerful device to be used to run a backup, failover, and/or overflow NIO platform for multiple other NIO platforms. As the NIO platform 402a can be configured with whatever services are desired, this provides a very flexible solution that can be easily reconfigured to match changes in the configurations of the other NIO platforms and ensure continued support.

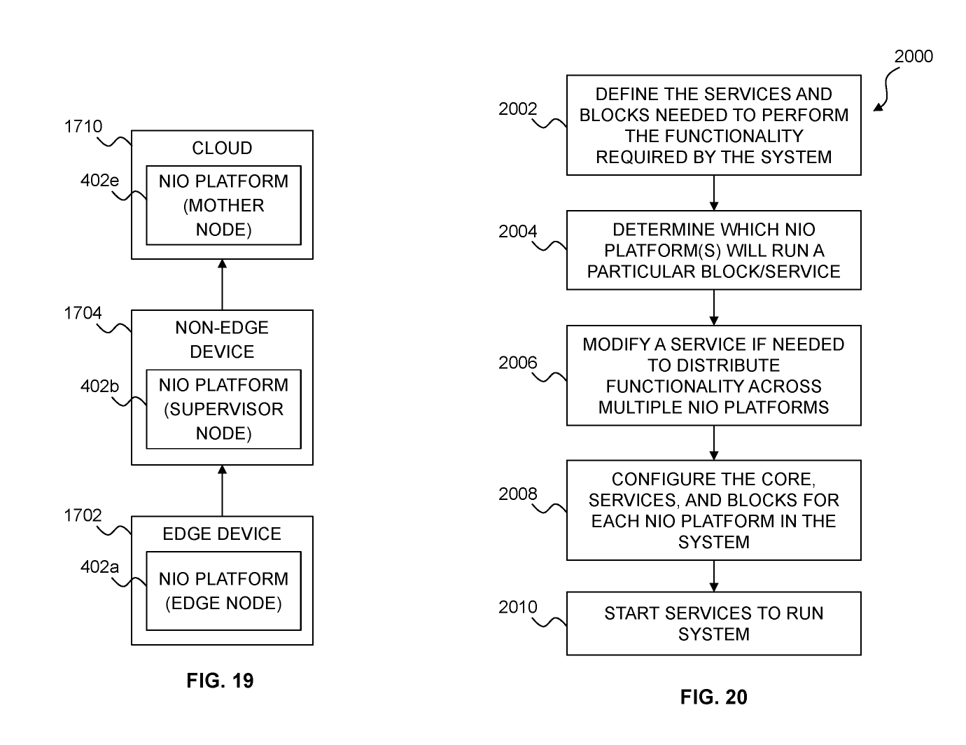

Referring to FIG. 19 and with continued reference to FIG. 17, one embodiment of the system 1700 organizes the various NIO platforms 402a-402e in an arrangement of edge nodes, a supervisor node, and a mother node. In this example, the NIO platforms 402a, 402c, and 402d are edge nodes, the NIO platform 402b is a supervisor node, and the NIO platform 402e is a mother node. This hierarchy is shown in FIG. 19 for the NIO platforms 402a, 402b, and 402e.

For purposes of example, the edge nodes provided by the NIO platforms 402a, 402c, and 402d are distributed around a manufacturing facility. The NIO platforms 402a, 402c, and 402d connect to sensors, process all sensor data, and perform any local actuations (e.g., turning an LED on or off, or actuating a motor). The edge nodes are generally located out in the facility and so may be distributed based on logical locations for edge nodes within that facility.

The supervisor node provided by the NIO platform 402b monitors some or all of the edge nodes (only the NIO platforms 402a and 402c in FIG. 17) and their services. The NIO platform 402b detects when a primary node goes down and commands a backup node to take over. The supervisor node may also aggregate data from the NIO platforms being supervised, as well as make decisions that require data from multiple NIO platforms. The supervisor node may also handle any internet actuations (e.g., publish to a socket or save data to a cloud or local database). In some embodiments, the supervisor node may perform its actuations directly, while in other embodiments the supervisor node may perform its actuations via the mother node. The supervisor node may be located in different places, such as on a server local to the manufacturing facility or in the cloud.

The mother node provided by the NIO platform 402e monitors external access to the supervisor node and monitors that the supervisor node is running. The mother node is generally located in the cloud, although on site placement is also possible.

This arrangement of NIO platforms enables the formation of tiered systems where higher level NIO platforms can monitor lower level NIO platforms. The lowest level NIO platforms are edge nodes that interface with the devices, systems, and/or applications that are outside of the NIO platform network. Adding additional tiers of NIO platforms may enable the control structure to be extended with additional granularity. It is understood that the processing described in the preceding examples, as well as the communications between NIO platforms, may occur in real time. A real time system created using NIO platforms arranged in a tiered fashion as described herein is highly adaptable.

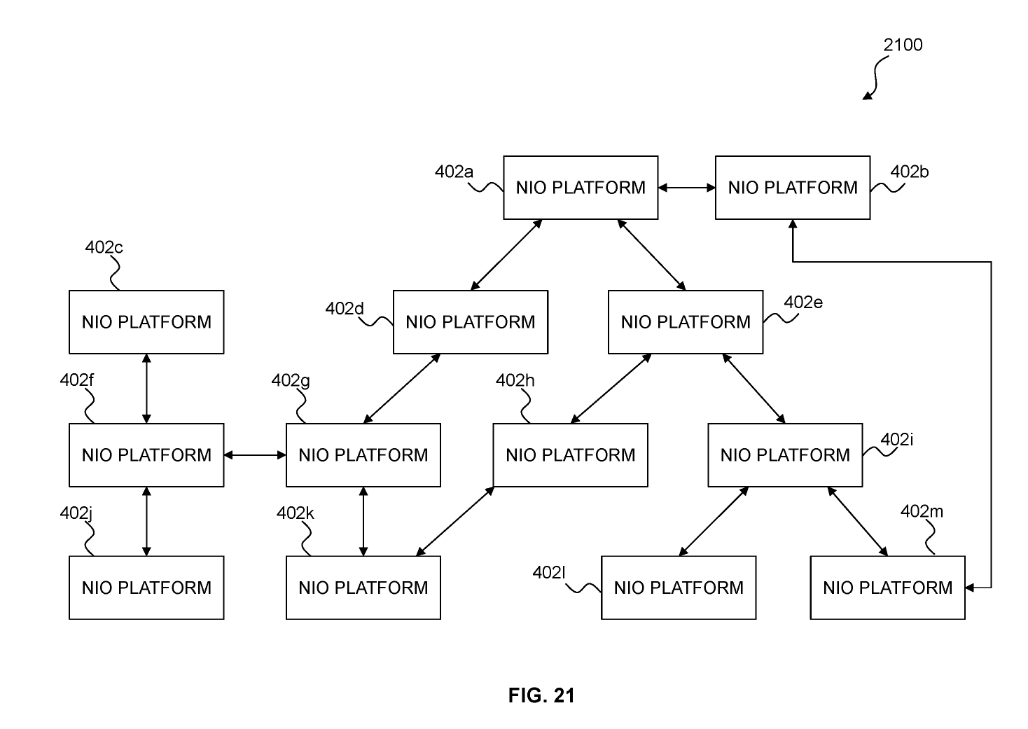

Referring to FIG. 20, a method 2000 illustrates one embodiment of a process that may be executed to create a system of NIO platforms, such as the system 1700 of FIG. 17. It is understood that the method 2000 may be executed over a period of time and may be iterative in nature, with steps being repeated as needed until the overall method has been performed.

In step 2002, the services 230 and blocks 232 that are needed to perform the system's functionality are defined. The particular services 230 and blocks 232 may vary widely across different systems due to the various requirements of a particular system. For example, a system for process control in a manufacturing facility will have very different requirements compared to an agricultural control system or a point of sale/inventory system. While many systems will have similar high level requirements (e.g., the need for real time processing, communication, and actuation) and will use the same basic NIO platform architecture to meet those requirements, the particular services 230 and blocks 232 will likely be significantly different for each system.

In step 2004, a determination is made as to which NIO platform in the system 1700 will run a particular block 232 and/or service 230. This step may include an analysis of the processing capabilities of various devices on which the NIO platforms are to be run. This allows the blocks 232 and/or services 230 to be distributed to take advantage of available processing resources. Alternatively, devices may be selected for particular NIO platforms based on the processing requirements imposed by the services 230 assigned to that particular NIO platform. Accordingly, step 2004 may be approached in different ways depending on such factors as whether the devices to be used can be selected or whether already installed devices must be used.

In step 2006, one or more of the services 230 may be modified if needed. For example, if a service 230 defined in step 2002 would be more efficient if distributed across multiple NIO platforms or if the service 230 as originally designed is too resource intensive for a particular device, the service 230 may be redesigned as multiple separate but connected services. Step 2006 may be omitted if not needed. In step 2008, the core 228, services 230, and blocks 232 for each NIO platform within the system 1700 are configured. In step 2010, the service 230 are started to run the system 1700.

Referring to FIG. 21, one embodiment of a system 2000 includes NIO platforms 402a-402m. The various NIO platforms 402a-402m may be configured identically or each of the NIO platforms 402a-402m may have a different configuration. As shown in FIG. 21, there are many possible connections between NIO platforms in the tiered system 2100, including vertical connections between higher/lower tiered NIO platforms and horizontal connections between NIO platforms in the same tier. As shown by the direct connection between NIO platforms 402b and 402m, intermediate tiers may be bypassed if desired. Services may be distributed in many different ways throughout the system 2100.

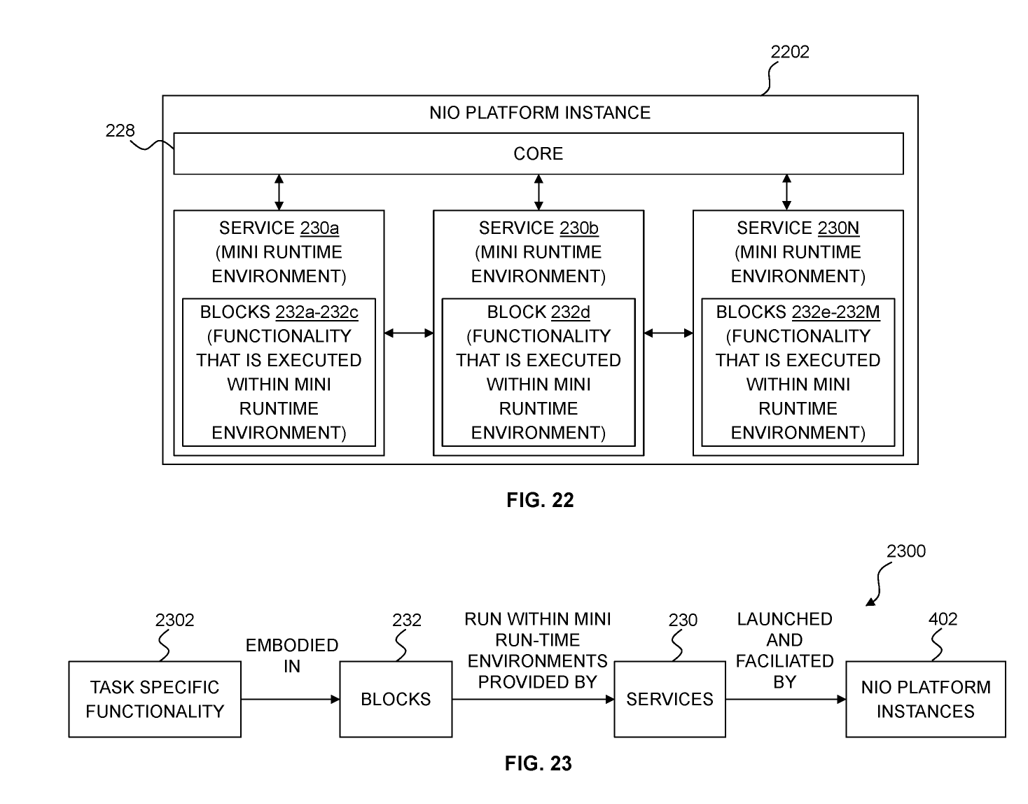

Referring to FIG. 22, one embodiment of a NIO platform instance 2202 illustrates a different perspective of the NIO platform instance 402 of FIG. 3B. The NIO platform instance 2202 (which may be similar or identical to the NIO platform 100 of FIG. 1A, 200 of FIG. 2A, 300 of FIG. 3A, and/or 402 of FIGS. 4A and 4B) is illustrated from the perspective of the task specific functionality that is embodied in the blocks. As described in previously referenced U.S. patent application Ser. No. 14/885,629, services 230 provide a framework within which blocks 232 are run, and a block cannot run outside of a service. This means that a service 230 can be viewed as a wrapper around a particular set of blocks 232 that provides a mini runtime environment for those blocks.

From this perspective, a service 230 is a configured wrapper that provides a mini runtime environment for the blocks 232 associated with the service. The base service class 202 is a generic wrapper that can be configured to provide the mini runtime environment for a particular set of blocks 232. The base block class 1806 provides a generic component designed to operate within the mini runtime environment provided by a service 230. A block 232 is a component that is designed to run within the mini runtime environment provided by a service 230, and generally has been extended from the base block class 1806 to contain task specific functionality that is available when the block 232 is running within the mini runtime environment. The purpose of the core 228 is to launch and facilitate the mini runtime environments.

To be clear, these are the same services 230, blocks 232, base service class 202, base block class 1806, and core 228 that have been described previously in detail. However, this perspective focuses on the task specific functionality that is to be delivered, and views the NIO platform 2202 as the architecture that defines how that task specific functionality is organized, managed, and run. Accordingly, the NIO platform 2202 provides the ability to take task specific functionality and run that task specific functionality in one or more mini runtime environments. Multiple NIO platforms 2202 can be combined into a distributed system of mini runtime environments.

Referring to FIG. 23, a diagram 2300 illustrates one embodiment of a hierarchical flow that begins with task specific functionality 2302 and ends with NIO platform instances 402. More specifically, the task specific functionality 2302 is encapsulated within blocks 232, and those blocks may be divided into groups (not shown). Each group of blocks is wrapped in a service 230. Each service 230 is configured to run its blocks 232 within the framework (e.g., the mini runtime environment) provided by the service 230. The configuration of a service may be used to control some aspects of that particular service's mini runtime environment. This means that even though the basic mini runtime environment is the same across all the services 230, various differences may still exist (e.g., the identification of the particular blocks 232 to be run by the service 230, the order of execution of those blocks 232, and/or whether the blocks 232 are to be executed synchronously or asynchronously).

Accordingly, the basic mini runtime environment provided by the base service class 202 ensures that any block 232 that is based on the base block class 1806 will operate within a service 230 in a known manner, and the configuration information for the particular service enables the service to run a particular set of blocks. The services 230 can be started and stopped by the core 228 of the NIO platform 402 that is configured to run that service.

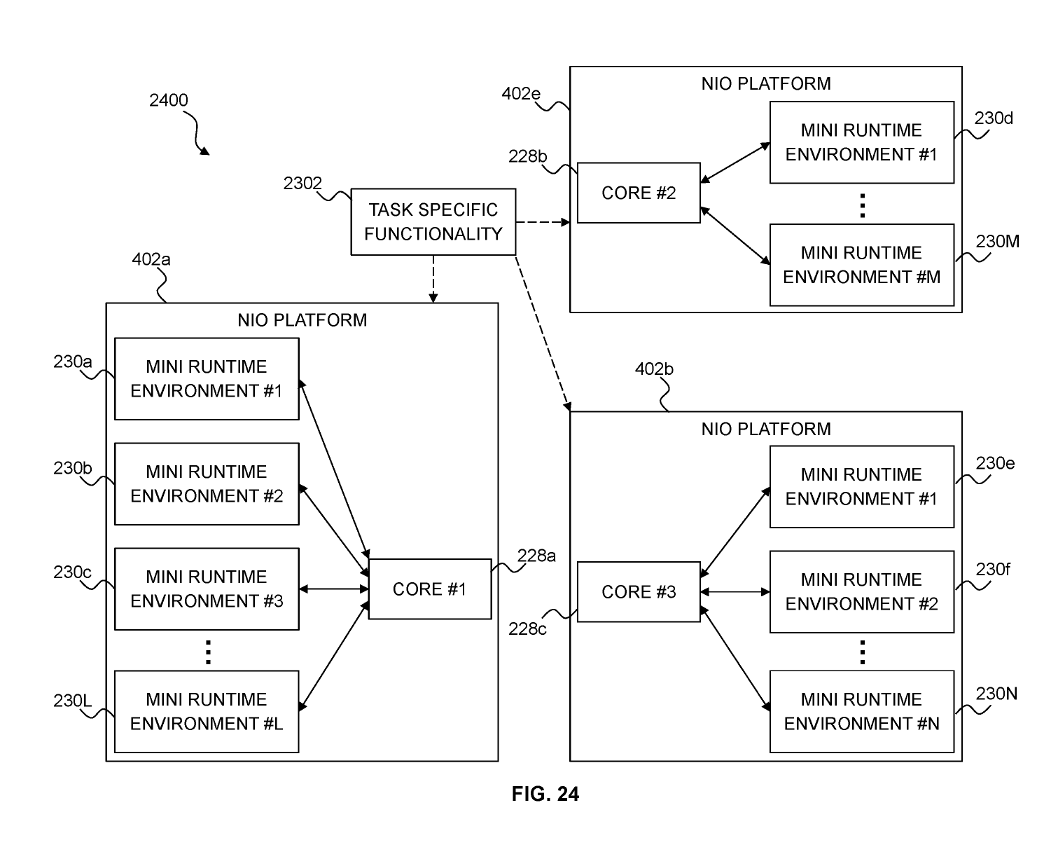

Referring to FIG. 24, one embodiment of a system 2400 is illustrated with the task specific functionality 2302 of FIG. 23. As described with respect to FIGS. 15-21, the flexibility provided by the use of blocks 232 and services 230 enables task specific functionality to be added, removed, modified, and/or distributed across a system containing multiple NIO platform instances in many different ways without requiring major modifications to the system architecture. This is further illustrated in FIG. 24 with NIO platforms 402a, 402b, and 402e, which may correspond, for example, to identically labeled platforms in FIGS. 18A-18C.

Each NIO platform 402a, 402b, and 402e can support multiple mini runtime environments (i.e., services) within which the task specific functionality 2302 can be executed. For example, the NIO platform 402a includes a core 228a (core #1) and multiple mini runtime environments 230a-230L. The NIO platform 402b includes a core 228b (core #2) and multiple mini runtime environments 230d-230M. The NIO platform 402c includes a core 228c (core #3) and multiple mini runtime environments 230e-230N. The task specific functionality 2302 can be located in some or all of the mini runtime environments, with each mini runtime environment being stopped and started as needed by the respective cores.

Accordingly, to develop a distributed system, various device/network capabilities (e.g., processor speed, memory, communication protocols, and/or bandwidth) may be identified (for an existing system) or specified (for a new system or a system being modified). The desired task specific functionality 2302 can then be distributed using a block/service distribution that accounts for those capabilities. Because of the NIO platform's architecture and the way it is able to run asynchronous and independent blocks in any mini runtime environment, the functionality can be divided in many different ways without requiring any substantial system changes as long as the device on which a particular block/service is to be run meets any requirements.

For example, in one system, edge devices may be sufficiently powerful to process relatively large amounts of data, thereby reducing network traffic. In another system, edge devices may not be so powerful and will have to transfer more data to NIO platforms on other devices for processing, thereby increasing network traffic. Because of the flexibility provided by the NIO platforms, this balancing of tradeoffs may be accomplished by distributing the same task specific functionality in different ways for each system.

For example, moving a block from a service on one device to a service on another device may be as simple as modifying the core and service configurations on both NIO platforms, updating the block's configuration (if needed), storing the block on the second NIO platform (if not already there), and updating existing input/output blocks or adding additional input/output blocks to the services (if needed) to move data from one service to another. Additionally, if a device running a NIO platform instance is powerful enough, additional services can be run by the existing NIO platform instance and/or another NIO platform instance with overlapping or totally different functionality can be started on the same device.

Accordingly, the use of distributed NIO platforms enables the design and implementation of systems where functionality, including real time processing functionality, can be shifted between NIO platforms as desired. Although some system limitations may not be addressed by moving functionality from one NIO platform to another (e.g., an edge device may not have the processing speed needed to process enough data to reduce network load as desired on a slow network), such flexibility can be advantageous when planning a system and/or modifying/upgrading an existing system. The use of NIO platforms provides a flexible distributed solution that does not lock a user into a particular configuration, but rather allows changes to be made on a per block or per service basis at any time and allows functionality to be added or removed, or simply stopped and started, as desired.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

For example, in one embodiment, a system for enabling configurable multi-tiered processing using multiple instances of a configurable platform running on different devices includes a first configurable platform and a second configurable platform, wherein each of the first and second configurable platforms are based on a similar core and include the core that interacts with an operating system on a device on which the core is run and is configured to run a plurality of services on the device; a plurality of blocks, wherein each block is based on a base block class and is customized with task specific processing functionality that can be executed only through one of the services; the plurality of services, wherein each of the services is based on a base service class and is configured to use at least one of the blocks for the block's task specific processing functionality; and at least one configuration file that defines the services to be run by the core and defines a configuration of each of the blocks, wherein the first configurable platform is configured to use at least one of the services running on the first configurable platform to receive a first input from an external source, process the first input to create a first output, and send the first output as a second input to at least one of the services running on the second configurable platform for further processing into a second output.

In some embodiments, the first input is one of a plurality of inputs received by the first configurable platform from a plurality of external sources.

In some embodiments, the plurality of external sources include a first device that produces first data of a first protocol type and a second device that produces second data of a second protocol type, and wherein a first block within the first configurable platform is configured to convert the first data into an internal data structure for use within the first configurable platform and a second block within the first configurable platform is configured to convert the second data into the internal data structure for use within the first configurable platform.

In some embodiments, the first block is controlled by a first service running on the first configurable platform and the second block is controlled by a second service running on the first configurable platform.

In some embodiments, the first and second blocks are controlled by a single one of the services running on the first configurable platform.

In some embodiments, the first configurable platform is configured to use at least one of the services running on the first configurable platform to process the first input to create a third output, and send the third output to the external source.

In some embodiments, the third output is an actuation signal.

In some embodiments, the system further includes a third configurable platform that is based on the similar core and includes the core that interacts with an operating system on a device on which the core is run and is configured to run a plurality of services on the device; a plurality of blocks, wherein each block is based on the base block class and is customized with task specific processing functionality that can be executed only through one of the services; the plurality of services, wherein each of the services is based on the base service class and is configured to use at least one of the blocks for the block's task specific processing functionality; and at least one configuration file that defines the services to be run by the core and defines a configuration of each of the blocks.

In some embodiments, the second configurable platform is configured to use at least one of the services running on the second configurable platform to send the second output to at least one of the services running on the third configurable platform for further processing.

In some embodiments, the third configurable platform is configured to use at least one of the services running on the third configurable platform to receive a third input from an external source, process the third input to create a third output, and send the third output as a fourth input to at least one of the services running on the second configurable platform for further processing.

In some embodiments, the second configurable platform is configured to process the fourth input to create a fourth output.

In some embodiments, the second configurable platform is configured to send the fourth output to at least one of the first and third configurable platforms.

In some embodiments, the second configurable platform is configured to process the fourth input to create part of the second output.

In some embodiments, the third configurable platform is configured to use at least one of the services running on the third configurable platform to receive a third input from an external source, process the third input to create a third output, and send the third output as a fourth input to at least one of the services running on the first configurable platform for further processing.

In some embodiments, the first configurable platform is configured to process the fourth input to create a fourth output.

In some embodiments, the first configurable platform is configured to send the fourth output to at least one of the second and third configurable platforms.

In some embodiments, the first configurable platform is configured to process the fourth input to create part of the first output.

In some embodiments, the third configurable platform is configured to monitor the second configurable platform, and wherein the second configurable platform is configured to monitor the first configurable platform.

In some embodiments, the second configurable platform is configured to monitor the first configurable platform.

In another embodiment, a system for enabling configurable multi-tiered processing using multiple instances of a configurable platform running on different devices includes a first configurable platform and a second configurable platform, wherein each of the first and second configurable platforms are based on a similar core that is configured to run a plurality of configurable services, wherein each of the configurable services uses at least one block that provides the service with task specific processing functionality, and wherein the first configurable platform is configured to use its services to receive a first input from an external source, process the first input to create a first output, and send the first output as a second input to a service running on the second configurable platform.

In yet another embodiment, a system for enabling configurable multi-tiered processing using multiple instances of a configurable platform running on different devices includes a plurality of configurable platforms, wherein each of the configurable platforms are based on a similar core that is configured to run a plurality of configurable services, wherein each of the configurable services uses at least one block that provides the service with task specific processing functionality, and wherein a first configurable platform of the plurality of configurable platforms is configured to use its services to receive a first input from an external source, process the first input to create a first output, and send the first output as a second input to a service running on a second configurable platform of the plurality of configurable platforms.

In yet another embodiment, a method for creating a system using a plurality of configurable platforms having an identical architecture includes dividing task specific functionality into a plurality of subsets; selecting, for each of the subsets, one or more blocks containing the task specific functionality in that subset, wherein each of the blocks is designed to operate independently and asynchronously from other blocks within a mini runtime environment provided by a service, and wherein the task specific functionality contained within a block is only accessible when the block is running within the mini runtime environment; determining, for each block, which of the plurality of configurable platforms should run the task specific functionality contained within the block; defining a plurality of services to be used in the system, wherein each of the services provides a mini runtime environment for any blocks to be run by that service, and wherein defining the services includes assigning one or more of the blocks to each of the services; and assigning each of the services to one or more of the configurable platforms, wherein each of the configurable platforms includes a core that is configured to interact with an operating system of a device on which the configurable platform is running, and is also configured to launch any of the services assigned to that configurable platform, wherein the services can be independently started and stopped as needed to actuate the task specific functionality provided by the blocks within the services.

In some embodiments, the method further includes moving a first block assigned to a first service running on a first configurable platform within the system to a second service running on the first configurable platform in order to modify which service on the first configurable platform runs the first block's task specific functionality.

In some embodiments, moving the first block includes modifying configuration information of the first and second services.

In some embodiments, moving the first block includes modifying configuration information of the first block.

In some embodiments, the method further includes stopping the first and second services to move the first block; and starting the first and second services after the first block has been moved.

In some embodiments, the method further includes moving a first block assigned to a first service running on a first configurable platform within the system to a second service running on a second configurable platform within the system in order to modify which configurable platform within the system will run the first block's task specific functionality.

In some embodiments, moving the first block includes modifying configuration information of the first and second services.

In some embodiments, moving the first block includes modifying configuration information of the first block.

In some embodiments, making a block class for the first block accessible to the second configurable platform.

In some embodiments, the method further includes adding new task specific functionality to the system, wherein the method further includes: identifying a first block containing the new task specific functionality; determining which of the plurality of configurable platforms should run the new task specific functionality contained within the first block; and adding the first block to a first service on one of the plurality of configurable platforms.

In some embodiments, the method further includes encapsulating the new task specific functionality within the first block.

In some embodiments, the method further includes creating the first service prior to adding the first block to the first service.

In some embodiments, defining the plurality of services includes creating configuration information for each service that defines which blocks the service is to run.

In some embodiments, defining the plurality of services further includes defining an order of execution of blocks within the service.

In some embodiments, the order of execution is controlled by the service.

In some embodiments, determining, for each block, which of the plurality of configurable platforms should run the task specific functionality contained within the block includes accounting for each device's processing capabilities.

In some embodiments, determining, for each block, which of the plurality of configurable platforms should run the task specific functionality contained within the block includes accounting for an available network bandwidth for each device.

In some embodiments, determining, for each block, which of the plurality of configurable platforms should run the task specific functionality contained within the block includes determining whether the block is to run on an edge device.

In some embodiments, the method further includes determining whether a block exists for each subset; and encapsulating the task specific functionality in each subset for which a block does not exist in a new block.

In some embodiments, the method further includes determining whether a block exists for each subset; and modifying an existing block to encapsulate the task specific functionality in each subset for which a block does not exist.

In some embodiments, the method further includes starting and stopping the services independently as needed to actuate the task specific functionality provided by the blocks within the services.

In another embodiment, a configurable distributed system includes a plurality of configurable platforms having an identical architecture, wherein each configurable platform includes a core configured to launch a plurality of services, wherein the core is configured to interact with an operating system of a device on which the configurable platform is running; the plurality of services, wherein each of the plurality of services forms a mini runtime environment for at least one block; and a plurality of blocks, wherein each block is designed to operate within the mini runtime environment provided by any of the plurality of services, and wherein task specific functionality provided by each block can only be accessed when the block is running within one of the mini runtime environments, wherein the blocks can be distributed across the configurable platforms to form a desired configuration of the distributed system.

In another embodiment, a method for creating a system using a plurality of configurable platforms having an identical architecture includes selecting desired task specific functionality that is encapsulated in a plurality of blocks, wherein each of the blocks is designed to operate independently and asynchronously from other blocks within a mini runtime environment provided by a service, and wherein the task specific functionality contained within a block is only accessible when the block is running within the mini runtime environment; determining, for each block, which of the plurality of configurable platforms should run the task specific functionality contained within the block; defining a plurality of services to be used in the system, wherein each of the services provides a separate mini runtime environment for any blocks to be run by that service, and wherein defining the services includes assigning one or more of the blocks to each of the services; assigning each of the services to one or more of the configurable platforms, wherein each of the configurable platforms includes a core that is configured to interact with an operating system of a device on which the configurable platform is running, and is also configured to launch any of the services assigned to that configurable platform, wherein the services can be independently started and stopped as needed to actuate the task specific functionality provided by the blocks within the services.

In another embodiment, a method for creating a system using a plurality of configurable platforms having an identical architecture includes dividing task specific processing functionality into a plurality of subsets; encapsulating each of the subsets in one of a plurality of blocks, wherein each of the blocks is designed to operate independently and asynchronously from other blocks within a mini runtime environment provided by a service, and the task specific processing functionality contained within a block is only accessible when the block is running within the mini runtime environment; defining a plurality of services to be used in the system, wherein each of the services provides a separate mini runtime environment for any blocks to be run by that service, and wherein defining the services includes assigning one or more of the blocks to each of the services; distributing the services among the plurality of configurable platforms, wherein each of the configurable platforms includes a core that is configured to interact with an operating system of a device on which the configurable platform is running, and is also configured to launch any of the services assigned to that configurable platform, wherein the services can be independently started and stopped as needed to actuate the task specific functionality provided by the blocks within the services.

In some embodiments, defining the services includes: selecting, for each block, which of the configurable platforms should be used to support the block; and assigning the block to a service on the selected configurable platform

In some embodiments, a method for creating a system using a plurality of configurable platforms based on an identical architecture includes identifying a plurality of services needed to provide specified functionality for the system, wherein each service is to be run by one of a plurality of configurable platforms running on one of a plurality of devices within the system, wherein each of the configurable platforms is based on an identical core that will interact with the device on which the configurable platform is to run, and wherein identifying each of the services includes identifying a plurality of blocks that will operate independently and asynchronously from one another within a mini runtime environment provided by the service to provide the service with task specific processing functionality; determining an ideal distribution of the services across the plurality of configurable platforms; determining that a first service of the plurality of services cannot be run on a first device of the plurality of devices, wherein the first service uses a first set of blocks from the plurality of blocks; separating the first service into a second service and a third service by dividing the first set of blocks into a first subset and a second subset; assigning the first subset to the second service; and assigning the second subset to the third service, wherein each of the second and third services is a subset of functionality provided by the first service; configuring a first one of the configurable platforms that is located on the first device to run the second service; and configuring a second one of the configurable platforms that is located on a second device of the plurality of devices to run the third service.

In some embodiments, the second service includes an output block in addition to the first subset of blocks, wherein the third service includes an input block in addition to the second subset of blocks, and wherein the output block and the input block connect the second service and the third service so that the second service and the third service provide the functionality of the first service when connected.

In some embodiments, the output block and the input block are the only blocks that are different from the plurality of blocks used in the first service.

In another embodiment, a method for creating a system using a plurality of configurable platforms based on an identical architecture includes identifying a plurality of services needed to provide specified functionality for the system, wherein each service is to be run by one of a plurality of configurable platforms running on one of a plurality of devices within the system, wherein each of the configurable platforms is based on an identical core that will interact with the device on which the configurable platform is to run, and wherein identifying each of the services includes identifying a plurality of blocks that will operate independently and asynchronously from one another within a mini runtime environment provided by the service to provide the service with task specific processing functionality; determining that a first service of the plurality of services cannot be run on a first device of the plurality of devices, wherein the first service uses a plurality of blocks; separating the first service into N services, wherein N is a whole number, by dividing the first plurality of blocks into N subsets; and assigning each of the N subsets to a separate one of the N services; and locating each of the N services on a separate device of the plurality of devices.

In some embodiments, each of the N services includes at least one of an input block and an output block in addition to the N subset of blocks assigned to the service, and wherein the output blocks and the input blocks are used to connect the N services to provide the functionality of the first service.

In some embodiments, the output blocks and the input blocks are the only blocks that are different from the plurality of blocks used in the first service.

In another embodiment, a method for distributing services across a plurality of devices includes identifying a plurality of services, wherein each service is associated with a plurality of blocks that define the processing functionality of the service; determining a distribution of the services across the plurality of devices; determining whether to subdivide any of the services in order to distribute the service across two or more of the devices; subdividing any service that is to be subdivided by dividing the blocks associated with the service into two or more subsets and creating a new service for each of the subsets; and assigning each of the new services to a different device.

In some embodiments, the method further includes identifying a processing capability of each of the devices, wherein determining whether to subdivide any one of the services is based on the processing needs of the service relative to the processing capability of the device on which the service is to be run.

In still another embodiment, a method for creating a system using a plurality of configurable platforms includes defining a plurality of services needed to provide specified functionality for the system, wherein each service is to be run by a core of one of a plurality of configurable platforms within the system, wherein each of the configurable platforms are based on a similar core, and wherein defining each of the services includes defining at least one block that provides the service with task specific processing functionality; determining which of a plurality of configurable platforms will run each of the plurality of services; for each of the configurable platforms, configuring a core and any of the services to be run by the configurable platform; and starting the services.

What is claimed is:

1. A method for creating a system using a plurality of configurable platforms having an identical architecture, the method comprising:
dividing task specific functionality into a plurality of subsets;
selecting, for each of the subsets, one or more blocks containing the task specific functionality in that subset, wherein each of the blocks is designed to operate independently and asynchronously from other blocks within a mini runtime environment provided by a service, and wherein the task specific functionality contained within a block is only accessible when the block is running within the mini runtime environment;
determining, for each block, which of the plurality of configurable platforms should run the task specific functionality contained within the block;
defining a plurality of services to be used in the system, wherein each of the services provides a mini runtime environment for any blocks to be run by that service, and wherein defining the services includes assigning one or more of the blocks to each of the services; and
assigning each of the services to one or more of the configurable platforms, wherein each of the configurable platforms includes a core that is configured to interact with an operating system of a device on which the configurable platform is running, and is also configured to launch any of the services assigned to that configurable platform, wherein the services can be independently started and stopped as needed to actuate the task specific functionality provided by the blocks within the services.

2. The method of claim 1 further comprising moving a first block assigned to a first service running on a first configurable platform within the system to a second service running on the first configurable platform in order to modify which service on the first configurable platform runs the first block's task specific functionality.

3. The method of claim 2 wherein moving the first block includes modifying configuration information of the first and second services.

4. The method of one of claim 2 or 3 wherein moving the first block includes modifying configuration information of the first block.

5. The method of one of claims 2 through 4 further comprising:
stopping the first and second services to move the first block; and
starting the first and second services after the first block has been moved.

6. The method of claim 1 further comprising moving a first block assigned to a first service running on a first configurable platform within the system to a second service running on a second configurable platform within the system in order to modify which configurable platform within the system will run the first block's task specific functionality.

7. The method of claim 6 wherein moving the first block includes modifying configuration information of the first and second services.

8. The method of one of claim 6 or 7 wherein moving the first block includes modifying configuration information of the first block.

9. The method of one of claims 6 through 8 further comprising making a block class for the first block accessible to the second configurable platform.

10. The method of claim 1 further comprising adding new task specific functionality to the system, wherein the method further includes:
identifying a first block containing the new task specific functionality;
determining which of the plurality of configurable platforms should run the new task specific functionality contained within the first block; and
adding the first block to a first service on one of the plurality of configurable platforms.

11. The method of claim 10 further comprising encapsulating the new task specific functionality within the first block.

12. The method of claim 10 further comprising creating the first service prior to adding the first block to the first service.

13. The method of one of claims 1 through 12 wherein defining the plurality of services includes creating configuration information for each service that defines which blocks the service is to run.

14. The method of one of claims 1 through 13 wherein defining the plurality of services further includes defining an order of execution of blocks within the service.

15. The method of claim 14 wherein the order of execution is controlled by the service.

16. The method of claim 1 wherein determining, for each block, which of the plurality of configurable platforms should run the task specific functionality contained within the block includes accounting for each device's processing capabilities.

17. The method of one of claim 1 or 16 wherein determining, for each block, which of the plurality of configurable platforms should run the task specific functionality contained within the block includes accounting for an available network bandwidth for each device.

18. The method of one of claim 1, 16, or 17 wherein determining, for each block, which of the plurality of configurable platforms should run the task specific functionality contained within the block includes determining whether the block is to run on an edge device.

19. The method of one of claim 1 through 18 further comprising:
determining whether a block exists for each subset; and
encapsulating the task specific functionality in each subset for which a block does not exist in a new block.

20. The method of one of claim 1 through 18 further comprising:
determining whether a block exists for each subset; and
modifying an existing block to encapsulate the task specific functionality in each subset for which a block does not exist.

21. The method of any of claims 1 through 20 further comprising starting and stopping the services independently as needed to actuate the task specific functionality provided by the blocks within the services.

22. A configurable distributed system comprising:
a plurality of configurable platforms having an identical architecture, wherein each configurable platform includes
a core configured to launch a plurality of services, wherein the core is configured to interact with an operating system of a device on which the configurable platform is running;
the plurality of services, wherein each of the plurality of services forms a mini runtime environment for at least one block; and
a plurality of blocks, wherein each block is designed to operate within the mini runtime environment provided by any of the plurality of services, and wherein task specific functionality provided by each block can only be accessed when the block is running within one of the mini runtime environments,
wherein the blocks can be distributed across the configurable platforms to form a desired configuration of the distributed system.
